(19) United States
(12) Patent Application Publication
(10) Pub. No.: US 2010/0162112 A1
(43) Pub. Date: Jun. 24, 2010

(54) REPRODUCTION PROCESSING METHOD, COMPUTER SYSTEM, AND PROGRAM

(75) Inventors: Kentaro WATANABE, Yokohama (JP); Yoshimasa MASUOKA, Kunitachi (JP)

Correspondence Address: BRUNDIDGE & STANGER, P.C., 2318 MILL ROAD, SUITE 1020, ALEXANDRIA, VA, 22314, US

(73) Assignee: Hitachi,Ltd.

(21) Appl. No.: 12/535,161

(22) Filed: Aug. 4, 2009

(30) Foreign Application Priority Data
Dec. 18, 2008 (JP) 2008-322343

(51) Int. Cl. G06F 3/048; G06F 9/46

(52) U.S. Cl. 715/704; 718/101

(57) ABSTRACT

Provided is a reproduction processing method of reproducing user's operation of a computer system, the reproduction processing method comprising: storing contents of the user's operation; transmitting the stored contents of the user's operation; determining a reproduction unit of the at least one reproduction unit for executing a reproduction processing according to the contents of the user's operation; determining a schedule of executing the reproduction processing; transmitting the stored contents of the user's operation and the determined schedule; and executing the reproduction processing based on the contents of the user's operation and the schedule.

### CLAIM OF PRIORITY

The present application claims priority from Japanese patent application JP2008-322343 filed on Dec. 18, 2008, the content of which is hereby incorporated by reference into this application.

### BACKGROUND OF THE INVENTION

This invention relates to a reproduction processing method, a computer system, and a program, and more particularly, to a reproduction processing method, the computer system, and a program for measuring response time of a computer system.

Response time of the computer system is an important performance index used by an administrator for understanding an operating status of the computer system. The administrator of the computer system periodically measures response time and detects a failure of the computer system from degradation of the response time. In the conventional art, for example, JP 2003-298647 A proposes a system for measuring response time by using a measurement system.

As a method for measuring response time of a web system, for example, a method discussed in JP 2004-185463 A is generally used, in which a measurement system generates a series of web access operations assumed to be executed by a user of the web system as operations called web transactions in a pseudo manner, periodically reproduces the generated web transactions by a program, and measures response time of the web transactions expended for the reproduction.

### SUMMARY OF THE INVENTION

As described above, in the system for measuring the response time of the web system, especially in the large web system, an environment for storing a web operation may be different from an environment for reproducing a stored operation. For example, there is a method involving storing an operation performed on the web system by each web client in a computer environment, and operating reproduction processings en bloc in the computer environment of a web server. In this case, a processing delay caused by a reproduction processing has to be prevented without increasing loads on the computer of the web server while reducing the number of computers of the web server for reproduction.

In a reproduction processing of a web operation, an original web operation has to be faithfully reproduced by the reproduction processing. However, when setting information of an environment where the original web operation has been originally executed is different from setting information of an environment where the original web operation is executed by the reproduction processing, a web browser performs a different processing from that performed at the time of storing the original web operation in the reproduction processing, and hence the reproduction processing can not exactly executed. To solve this problem, an environment for executing the reproduction processing has to be prepared corresponding to an environment where the original web operation is executed for each reproduction processing. However, preparing the environment for a reproduction processing according to the original environment necessitates many environments for the reproduction processing. As a result, the number of physical servers constituting the environments for the reproduction processing increases.

In measurement for executing reproduction for respective conditions of setting information of the web browser to compare response time, many environments for reproduction have to be prepared. For example, when execution of a reproduction processing using a given cookie is compared with execution not using the given cookie, an environment for reproduction has be prepared for each case.

In the web browser, a consumption amount of computer resources such as a memory and a CPU is large, and loads during browsing from a user are high. Thus, when a plurality of processings using the web browser is executed simultaneously on the same physical server, there is a possibility that loads on computer resources may increase to cause a shortage of the computer resources, and a failure may occur in the computer to delay the reproduction processing.

It is an object of this invention to provide a computer system capable of preventing a processing delay of a reproduction processing without increasing loads on a computer while suppressing an increase in number of computers constituting an environment of the reproduction processing.

According to an exemplary embodiment of this invention, there is provided a reproduction processing method of reproducing user's operation of a computer system which includes at least one processor for executing a program and a memory coupled to the at least one processor, the processor being configured to realize a storage processing unit for storing user's operation of the computer system, at least one reproduction unit for reproducing the user's operation, and a management unit for managing a schedule of the reproduction by executing the program, the reproduction processing method comprising: storing, by the storage processing unit, contents of the user's operation; transmitting, by the storage processing unit, the stored contents of the user's operation to the management unit; determining, by the management unit, a reproduction unit of the at least one reproduction unit for executing a reproduction processing according to the contents of the user's operation; determining, by the management unit, a schedule of executing the reproduction processing; transmitting, by the management unit, the stored contents of the user's operation and the determined schedule to the determined reproduction unit; and executing, by the determined reproduction unit, the reproduction processing based on the received contents of the user's operation and the schedule.

The exemplary embodiment of this invention enables a reproduction processing without increasing loads of a reproduction processing environment.

### BRIEF DESCRIPTION OF THE DRAWINGS

FIG. 1 is a block diagram illustrating a configuration of a computer system according to a first embodiment of this invention.

FIG. 2 illustrates a reproduction operation table according to the first embodiment of this invention.

FIG. 3 illustrates a reproduction processing table according to the first embodiment of this invention.

FIG. 4 illustrates a setting information table according to the first embodiment of this invention.

FIG. 5 illustrates a reproduction processing execution schedule table according to the first embodiment of this invention.

FIG. 6 illustrates a response time measurement table according to the first embodiment of this invention.

FIG. 7 illustrates a system configuration table according to the first embodiment of this invention.

FIG. 8 illustrates a table of restriction on number of reproduction processings according to the first embodiment of this invention.

FIG. 9 illustrates a response time threshold value table according to the first embodiment of this invention.

FIG. 10 illustrates a setting event correspondence table according to the first embodiment of this invention.

FIG. 11 illustrates an environment configuration table according to the first embodiment of this invention.

FIG. 12 is a block diagram illustrating a hardware configuration of the computer system according to this embodiment of this invention.

FIG. 13 is a flowchart illustrating overall processing according to the first embodiment of this invention.

FIG. 14 is a flowchart illustrating processing of executing testing to determine a reproduction environment according to the first embodiment of this invention.

FIG. 15 is a flowchart illustrating a determination processing of a reproduction environment using setting information and event information according to a second embodiment of this invention.

FIG. 16 is a flowchart illustrating a scheduling processing over reproduction environments according to a third embodiment of this invention.

FIG. 17 is a flowchart illustrating priority scheduling with a severity of a threshold value of response time in a fourth embodiment of this invention taken into consideration.

FIG. 18 is a flowchart illustrating control of simultaneous execution by distribution of resources among reproduction environments according to a fifth embodiment of this invention.

### DETAILED DESCRIPTION OF THE PREFERRED EMBODIMENTS

Referring to the drawings, preferred embodiments of this invention are described below in detail.

### First Embodiment

A computer system according to a first embodiment of this invention designates an environment for executing a reproduction operation stored in a reproduction processing storage unit 101 described below from a plurality of reproduction processing units 102, and processes a reproduction operation in the designated reproduction processing unit 102.

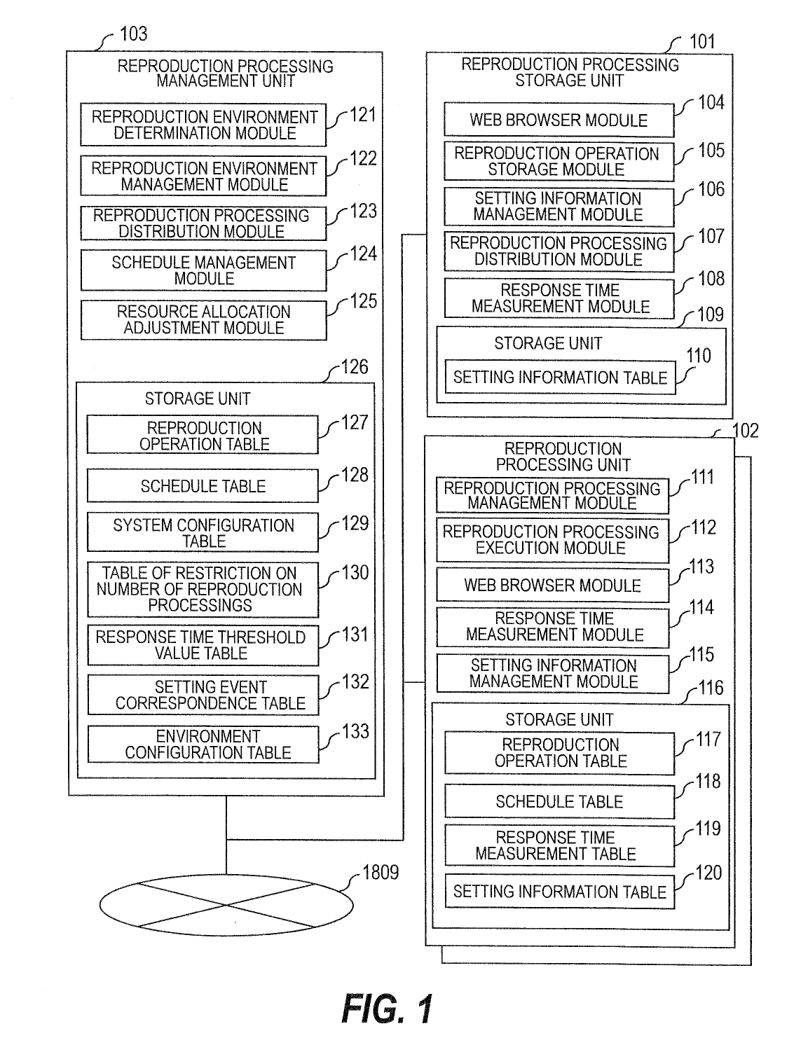

FIG. 1 is a block diagram illustrating a configuration of the computer system according to the first embodiment of this invention.

The computer system of the first embodiment includes a reproduction processing storage unit 101, a reproduction processing unit 102, and a reproduction processing management unit 103.

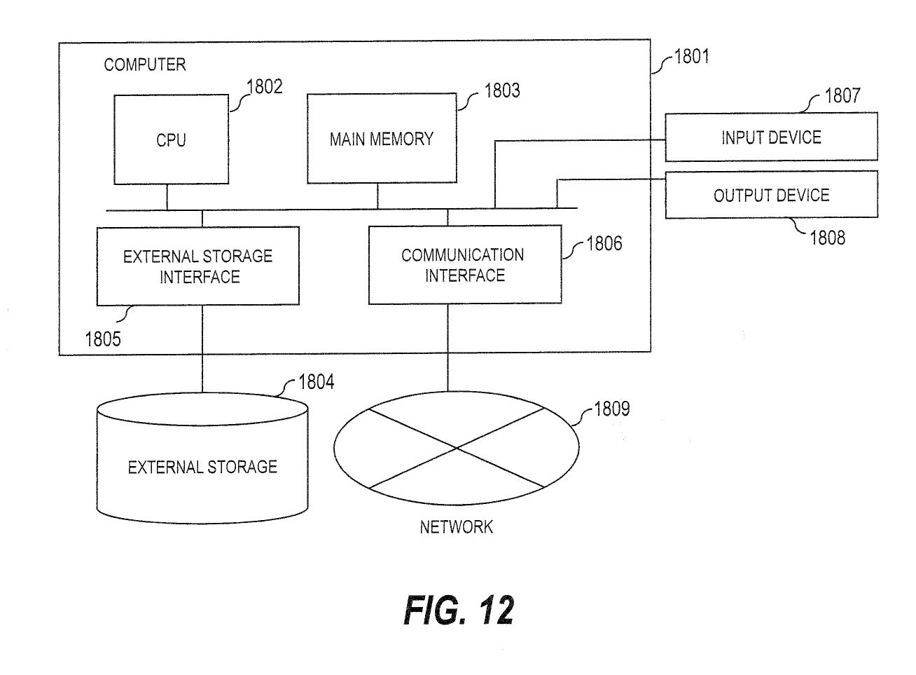

The reproduction processing storage unit 101, the reproduction processing unit 102, and the reproduction processing management unit 103 may be computers (e.g., logical computers) independent of one another, and reside on the same physical computer or over a plurality of physical computers. In an operating system operated on a computer 1801 (refer to FIG. 12), the administrator may set a computer environment by diving an operation authority of the computer 1801, for example, in a manner that one user account operates the reproduction processing storage unit 101 and another user account on the same computer 1801 operates the reproduction processing unit 102. Alternatively, the administrator may set a computer environment on a virtual computer operated on the computer 1801.

The reproduction processing storage unit 101, the reproduction processing unit 102, and the reproduction processing management unit 103 are interconnected via a network 1809. In FIG. 1, the reproduction processing storage unit 101, the reproduction processing unit 102, and the reproduction processing management unit 103 are interconnected via the network 1809, but this invention is not limited to this configuration, and these units may reside on the same physical computer or may be interconnected via the network 1809.

The reproduction processing storage unit 101 stores a reproduction operation input from the administrator to a web browser module 104 described below.

The reproduction processing storage unit 101 includes the web browser module 104, a reproduction operation storage module 105, a setting information management module 106, a reproduction processing distribution module 107, a response time measurement module 108, and a storage unit 109.

The web browser module 104 is a processing module for enabling the administrator or a user to browse web pages. The web browser module 104 downloads an HTML file, an image file, or a music file, analyzes a layout of the downloaded file, and displays or plays the file to the administrator or the user. The web browser module 104 receives input information generated by administrator's or user's mouse click or form input, transmits a page request message to the web server according to the received input information, and receives a page request response message from the web server to display a web page. In short, the web browser module 104 has a web browser control function.

The reproduction operation storage module 105 stores administrator's operation to the web browser unit. The operation is an operation to be reproduced (hereinafter referred to as reproduction operation). The reproduction operation is an operation in the web such as link click by a mouse or information input to a form. The reproduction operation includes an operation for a dialog associated with the web browser unit and generated by the above operation. The dialog associated with the web browser unit is, for example, an authentication dialog, a confirmation dialog, or a script error dialog.

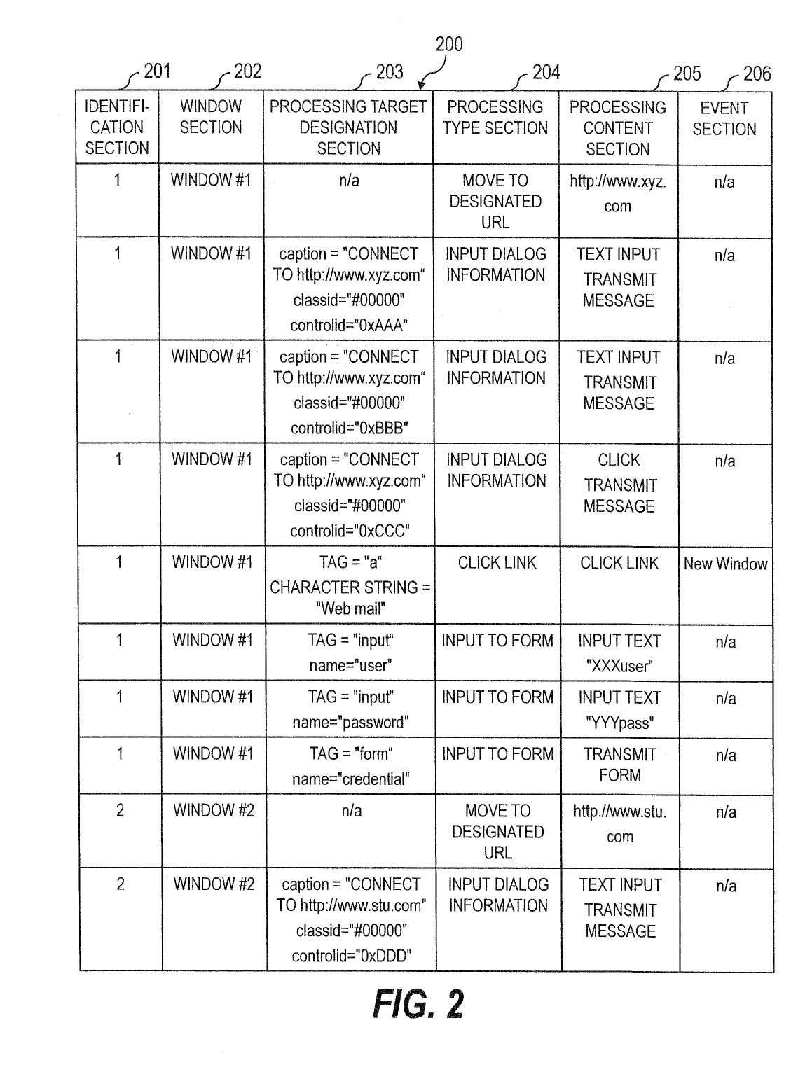

The reproduction operation storage module 105 generates, for example, a reproduction operation table 200 illustrated in FIG. 2 to store a reproduction operation.

FIG. 2 illustrates the reproduction operation table according to the first embodiment of this invention.

The reproduction operation table 200 stores, to enable the administrator to periodically measure response time at arbitrary time intervals, information of a reproduction operation for generating a series of web transactions. Records of the reproduction operation table 200 include information of each reproduction operation constituting a web transaction.

The reproduction operation storage module 105 detects an event log or a window message generated by a reproduction operation executed on the web browser unit by the administrator, designates each reproduction operation, and registers information to designate the reproduction operation in the records of the reproduction operation table 200, thereby generating the reproduction operation table 200.

The reproduction operation table 200 includes an identification section 201, a window section 202, a processing target designation section 203, a processing type section 204, a processing content section 205, and an event section 206.

The identification section 201 stores an identifier to identify a web transaction. When identifiers of the identification section 201 are identical, reproduction operations of the identical identifiers constitute identical web transactions. The identifiers are not limited to numerals, and the identification section 201 may include a character string or a bit string as long as the identifiers contain information to identify a web transaction. The reproduction operation storage module 105 generates, when generating the reproduction operation table 200, information for identifying a web transaction to store the information in the identification section 201.

The window section 202 includes identification information of the web browser unit targeted for a reproduction operation stored in each record. The window section 202 includes, when there is a plurality of windows or tabs targeted for a reproduction operation stored in the reproduction operation storage module 105, information for identifying one of the windows or tabs. In FIG. 2, the window section 202 includes an identifier based on a character string. However, an identifier based on a numeral or a bit string may be included.

The processing target designation section 203 includes information for designating a processing target of the reproduction operation stored in each record. When executing the reproduction operation, a reproduction operation execution module 112 described below refers to the information stored in the processing target designation section 203 to designate a target of a reproduction processing.

The processing type section 204 includes information on a type of the reproduction operation stored in each record. When executing the reproduction operation, the reproduction processing execution module 112 described below refers to the information stored in the processing type section 204 to designate a content of the reproduction processing.

The processing content section 205 includes information on a specific processing of the reproduction operation stored in each record. When executing the reproduction operation, the reproduction processing execution module 112 described below refers to the information stored in the processing type section 205 to designate a content of the reproduction processing.

The event section 206 includes an event log or a window message log generated by the reproduction operation stored in each record. The event section 206 is used in a third embodiment described below. When executing the reproduction operation, the reproduction processing execution module 112 described below refers to the information stored in the event section 206 to designate setting information of the reproduction processing storage unit 101 that will affect the reproduction operation based on an actually generated event log.

The event log and the window log store a plurality of events and a plurality of window messages in generation order. For example, the event is an event generated from the browser or a Document Object Model (DOM) event, such as a NewWindow event, a BeforeNavigate event (Navigating event), a DocumentCompleted event, a Click event, or an OnChange event. The window message is a message input/output on the window, such as a Win32 message.

The setting information management module 106 manages setting information of the reproduction processing storage unit 101. The setting information of the reproduction processing storage unit 101 is stored in the setting information table 110. The setting information management module 106 searches in the setting information table 110 in response to a request to return a value of relevant setting information. When changing of the setting information of the reproduction processing storage unit 101 is requested, the setting information management module 106 changes a value of relevant setting information of the setting information table 110.

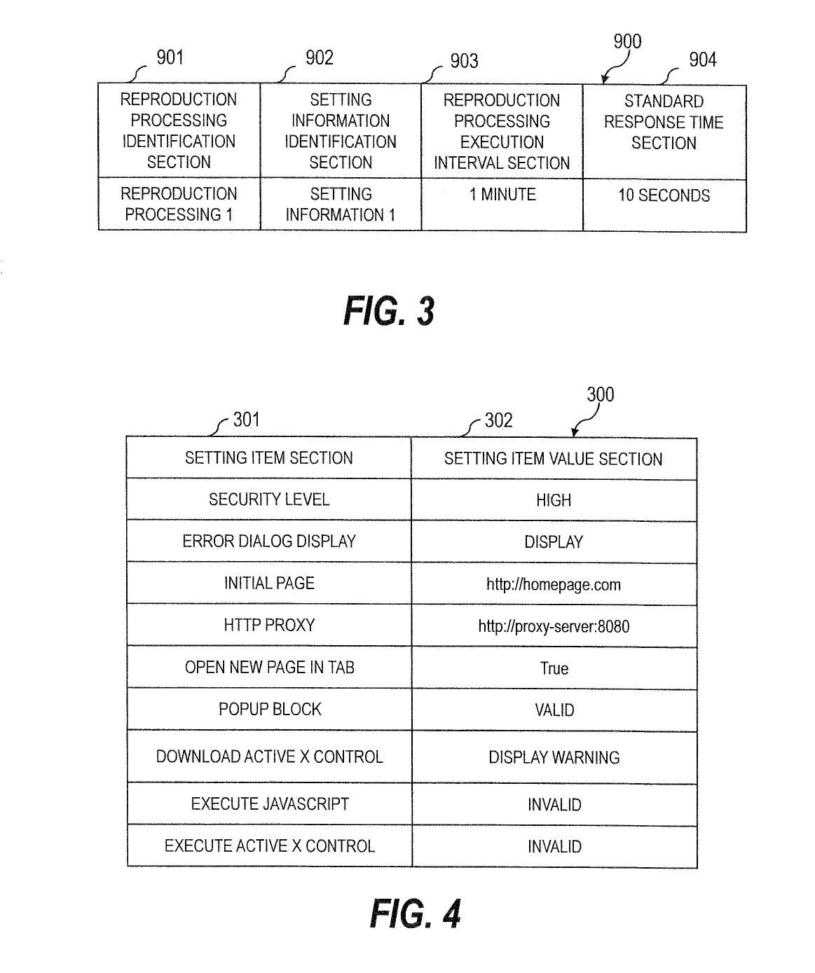

The reproduction processing distribution module 107 transmits the reproduction operation stored in the reproduction processing storage unit 101 to the reproduction processing management unit 103. The reproduction processing distribution module 107 obtains the reproduction operation stored by the reproduction operation storage module 105, and obtains the setting information table 110 by the setting information management module 106. The reproduction processing distribution module 107 generates a reproduction processing table 900 illustrated in FIG. 3, and transmits the reproduction processing table 900, the reproduction operation table 200, and the setting information table 110 to a reproduction environment management module 122 of the reproduction processing management unit 103.

FIG. 3 illustrates the reproduction processing table 900 according to the first embodiment of this invention.

The reproduction processing table 900 illustrated in FIG. 3 stores the reproduction operation designated by the reproduction operation table 200 and information on a time interval for designating a reproduction processing. Each record of the reproduction processing table 900 stores information for designating a reproduction processing.

The reproduction processing table 900 includes a reproduction processing identification section 901, a setting information identification section 902, a reproduction processing execution interval section 903, and a standard response time section 904.

The reproduction processing identification section 901 includes identification information of a reproduction processing stored in each record. The identification information is not limited to a character string, and the reproduction processing identification section 901 may include information based on a numeral or a bit string as long as it is information to identify each record. The reproduction operation storage module 105 stores a value of the identification section 201 of the reproduction operation table 200 illustrated in FIG. 1 in the reproduction processing identification section 901. In other words, each record of the reproduction processing table 900 corresponds to each web transaction. In this embodiment, a reproduction processing is a series of web transactions executed at fixed time intervals.

The setting information identification section 902 includes identification information of the setting information table 300. The identification information is not limited to a character string, and the setting information identification section 902 may include information based on a numeral or a bit string as long as it is information to identify the setting information table 300. In the setting information identification section 902, an arbitrary identifier may be stored by the reproduction processing storage unit 101 when the reproduction processing distribution module 107 transmits the reproduction processing table 900 to the reproduction processing management unit 103, or an arbitrary identifier may be stored by the reproduction processing management unit 103 after transmission of the reproduction processing table 900 to the reproduction processing management unit 103.

The reproduction processing execution interval section 903 includes a frequency of periodically performing a reproduction operation to measure response time of a reproduction processing. For example, when a reproduction operation is performed once per 1 minute, the reproduction processing distribution module 107 stores information indicating 1 minute in the reproduction processing execution interval section 903. The reproduction processing distribution section 107 stores a time interval of executing a reproduction operation input by the administrator in the reproduction processing execution interval section 903.

The standard response time section 904 includes, when a reproduction processing stored in each record is executed, time used as a reference for judging a length of response time of a reproduction operation by the administrator. In this embodiment, standard response time is a standard for predicting time necessary for executing a reproduction processing. While the reproduction operation storage module 105 stores a reproduction operation, the response time measurement module 108 described below measures response time expended for the reproduction operation to store the time as standard response time in the standard response time section 904.

The response time measurement module 108 measures response time expended when the reproduction operation is stored in the reproduction operation storage module 105. The measured response time is used as response time predicted to be needed for executing the reproduction operation during execution of the reproduction operation. The response time measurement module 108 stores the measured response time in the standard response time section 904 of the reproduction processing table 900.

The storage unit 109 stores information processed by the reproduction processing storage unit 101.

The storage unit 109 includes the setting information table 110. In this embodiment, the setting information table 110 is described as a table. However, the setting information table 110 is not limited to a table form, and any form may be used for storage as long as setting information may be read/written.

The setting information table 110 is a table for managing setting information of the reproduction processing storage unit 101. The setting information of the reproduction processing storage unit 101 is setting information that will affect processing of the web browser module 104. In other words, the setting information of the reproduction processing storage unit 101 is setting information of the web browser module 104 and setting information of the operating system of the computer system that includes the reproduction processing storage unit 101. For example, the information includes setting indicating a high/low security level, setting indicating whether or not to execute JavaScript (registered trademark) or setting indicating whether or not to execute ActiveX when the web browser module 104 is used, setting of URL displayed at the time of starting the web browser module 104, setting indicating whether or not to suppress a script error dialog, or setting of URL of a proxy server.

FIG. 4 illustrates the setting information table 300 according to the first embodiment of this invention.

The setting information table 110 has the same format as that of the setting information table 300 illustrated in FIG. 4. The setting information table 300 includes a setting item section 301 and a setting item value section 302. Setting information of the reproduction processing storage unit 101 is stored in each record of the setting information table 110. The setting information table 110 is provided for each reproduction processing storage unit 101 having a different setting environment.

The setting item section 301 stores an identifier of setting information indicated by each record. The identifier is not limited to a character string, and a numeral or a bit string may be used as long as an item of setting information may be identified.

The setting item value section 302 stores a setting value of setting information indicated by each record.

The reproduction processing unit 102 executes the reproduction operation stored in the reproduction processing storage unit 101 periodically or according to a request from the administrator, and measures response time expended for the reproduction operation.

The reproduction processing unit 102 includes a reproduction processing management module 111, a reproduction processing execution module 112, a web browser module 113, a response time measurement module 114, a setting information management module 115, and a storage unit 116.

The reproduction processing management module 111 manages a reproduction processing executed by the reproduction processing unit 102. The reproduction processing management module 111 receives an input of a reproduction processing to store the reproduction processing in a reproduction operation table 117, and refers to, deletes or corrects the reproduction processing stored in the reproduction operation table 117. The reproduction processing management module 111 receives a schedule of executing the reproduction processing to register the schedule in a schedule table 118 described below, and refers to, deletes or corrects the schedule of executing the reproduction processing from the schedule table 118.

The reproduction processing execution module 112 periodically executes the reproduction processing stored in the reproduction processing unit 102. The reproduction processing execution module 112 reads the execution schedule of the reproduction processing stored in the schedule table 118 described below, and executes the reproduction operation designated by the schedule at the time designated by the schedule. The reproduction operation reads a relevant part from the reproduction operation table 117 described below, and reproduction operations stored in the respective records are sequentially executed. The reproduction processing execution module 112 executes the reproduction processing by using the web browser module 113 described below.

The web browser module 113 is a processing module for enabling the administrator or the user to browse web pages. The web browser module 113 downloads an HTML file, an image file or a music file, and analyzes a layout of the downloaded file to display or play it for the administrator or the user. The web browser module 113 receives input information generated by administrator's or user's mouse click or form input, transmits a page request message to the web server according to the received input information, and receives a page request response message from the web server to display the web page. The web browser module 113 has the same function as that of the web browser module 104 of the reproduction processing storage unit 101. However, its setting may be different from that of the web browser module 104.

The response time measurement module 114 measures response time necessary for executing the reproduction processing stored, in the reproduction processing unit 102. The response time measurement module 114 measures response time expended for executing the reproduction processing by the reproduction processing execution module 112 to store the response time in a response time measurement table 119 described below. The response time measurement module 114 may measure response time by a series of web transactions executed by the reproduction processing execution module 112, or by each reproduction operation constituting a web transaction.

The setting information management module 115 manages setting information of the reproduction processing unit 102. The setting information of the reproduction processing unit 102 is stored in a setting information table 120 described below. The setting information management module 115 searches in the setting information table 120 in response to a request to return a value of relevant setting information. When there is a request for changing the setting information of the reproduction processing unit 102, the setting information management module 115 changes a value of relevant setting information of the setting information table 120.

The storage unit 116 is a storage area for storing information processed by the reproduction processing unit 102.

The storage unit 116 includes the reproduction operation table 117, the schedule table 118, the response time measurement table 119, and the setting information table 120. In this embodiment, the reproduction operations table 117, the schedule table 118, the response time measurement table 119, and the setting information table 120 are described as tables. However, the tables are not limited to a table form, and any form may be used for storage as long as pieces of information regarding a reproduction operation, a schedule, response time and setting information may be read/written.

The reproduction operation table 117 stores, to enable the administrator to periodically measure response time at an arbitrary time interval, information of a reproduction operation for generating a series of web transactions. A record of the reproduction operation table 117 includes information of each reproduction operation constituting a web transaction. For example, the reproduction operation table 117 has the same format as that of the reproduction operation table 200 illustrated in FIG. 2. The reproduction operation table 117 is generated based on contents of the reproduction operation table 200 received by the reproduction processing management module 111 of the reproduction processing unit 102 from the reproduction processing management unit 103.

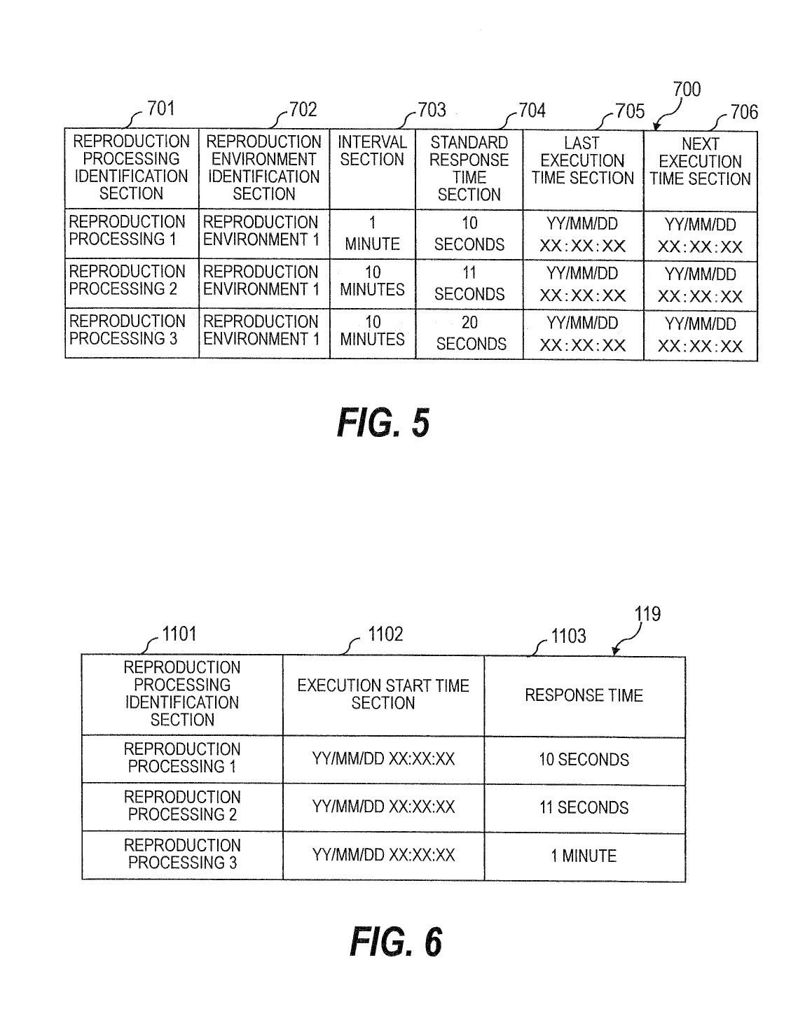

The reproduction processing execution schedule table 118 stores an execution schedule of the reproduction processing stored in the reproduction processing unit 102. For example, the reproduction processing execution schedule table 118 has the same format as that of a reproduction processing execution schedule table 700 illustrated in FIG. 5.

FIG. 5 illustrates the reproduction processing execution schedule table 700 according to the first embodiment of this invention.

Each record of the schedule table 700 stores information of the execution schedule of the reproduction operation executed by the reproduction processing unit 102. The schedule table 700 includes a reproduction processing identification section 701, a reproduction environment identification section 702, an interval section 703, a standard response time section 704, a last execution time section 705, and a next execution time section 706.

The reproduction processing identification section 701 stores identification information of a reproduction processing. Information stored in the reproduction processing identification section 701 is not limited to a character string but may be a numeral or a bit string as long as the information uniquely identifies the reproduction processing. The reproduction processing management module 111 stores, to register the reproduction processing in the reproduction processing unit 102, an identifier stored in the reproduction processing identification section 901 of the reproduction processing table 900 of FIG. 3 received from the reproduction processing management unit 103 in the reproduction processing identification section 701.

The reproduction environment identification section 702 stores information for identifying the reproduction processing unit 102. The information for identifying the reproduction processing unit 102 is not limited to a character string but may be a numeral or a bit string as long as the information uniquely identifies the reproduction processing unit 102. The reproduction processing unit 102 indicated by the reproduction environment identification section 702 is a reproduction processing unit 102 for executing a reproduction processing corresponding to a record. The reproduction processing management module 111 generates, to register the reproduction processing in the reproduction processing unit 102, information for identifying the reproduction processing unit 102 to store the information in the reproduction environment identification section 702.

The interval section 703 stores a frequency of executing a reproduction processing corresponding to a record, for example, information indicating a time interval of one operation per minute. Based on data of the interval section 703, the reproduction processing execution module 112 periodically executes a reproduction processing, and the response time measurement module 114 measures response time expended for the reproduction processing. To register the reproduction processing in the reproduction processing unit 102, the reproduction processing management module 111 stores received information stored in the reproduction processing execution interval section 903 of the reproduction processing table 900 illustrated in FIG. 3 in the interval section 703.

The standard response time section 704 includes, when a reproduction processing stored in the record is executed, a value that becomes a standard for predicting time necessary for executing the reproduction processing. To register the reproduction processing in the reproduction processing unit 102, the reproduction processing management module 111 stores received information stored in the standard response time section 903 of the reproduction processing table 900 illustrated in FIG. 3 in the standard response time section 704.

When the reproduction processing executing module 112 executes the reproduction processing corresponding to the record, time stored in the standard response time section 704 corresponds to time necessary for the reproduction processing. When the reproduction processing unit 102 executes a reproduction processing, the standard response time section 704 is used as a standard for estimating time necessary for the reproduction processing. In this embodiment, the response time expended for the reproduction processing in the reproduction processing storage unit 101 is set as the standard response time. However, the standard response time is not limited thereto, and if another response time that becomes a standard is obtained, the response time may be set as standard response time.

The last execution time section 705 stores last time of executing a reproduction processing corresponding to a record by the reproduction processing execution module 112. The reproduction processing execution module 112 executes the reproduction processing within a period of time stored in the interval section 703 from time stored in the last execution time section 705. When the reproduction processing execution module 112 starts the reproduction processing corresponding to the record, the reproduction processing management module 111 stores execution start time in the last execution time section 705.

The next execution time section 706 stores scheduled time of executing a next reproduction processing corresponding to a record by the reproduction processing execution module 112. When receiving the schedule table 700 of FIG. 5 transmitted from the schedule management module 124 of the reproduction processing management unit 103, the reproduction processing management module 111 stores a record of the schedule table 700 in the next execution time section 706.

The reproduction processing management module 111 searches for a record Y including an identifier matched with an identifier described in the reproduction processing identification section 701 of a record (record X) of the schedule table 700 sent from the reproduction processing management unit 103 in the reproduction processing identification section 701 of the reproduction processing execution schedule table 700 of the storage unit 116. Then, the reproduction processing management module 111 stores the time stored in the next execution time section 706 of the record X in the next execution time section 706 of the record Y.

The response time measurement table 119 stores response time measured by the response time measurement module 114. The measured response time is time expended for executing the reproduction processing by the reproduction processing execution module 112. Records of the response time measurement table 119 include a reproduction processing executed by the reproduction processing execution module 112, time for executing the reproduction processing, and response time expended for the reproduction processing.

FIG. 6 illustrates the response time measurement table 119 according to the first embodiment of this invention.

The response time measurement table 119 includes a reproduction processing identification section 1101, an execution start time section 1102, and a response time section 1103.

The reproduction processing identification section 1101 stores information for identifying a reproduction processing corresponding to a record. The response time measurement module 114 measures response time of the reproduction processing executed by the reproduction processing execution module 112 to add a new record to the response time measurement table 119. The response time measurement module 114 obtains an identifier of the reproduction processing executed by the reproduction processing execution module 112 to store the identifier of the reproduction processing in the reproduction processing identification section 1101 of the new record of the response time measurement table 119.

The reproduction processing execution module 112 requested for identification information of the reproduction processing from the response time measurement module 114 may search in the reproduction processing execution schedule table 118 to return identification information stored in the reproduction processing identification section 1101 of a record corresponding to the reproduction processing being executed to the response time measurement module 114.

The execution start time section 1102 stores time of starting execution of a reproduction processing corresponding to a record. The response time measurement module 114 stores the time of starting execution of the reproduction processing by the reproduction processing execution module 112 in the execution start time section 1102 when a record corresponding to the executed reproduction processing is generated.

The response time section 1103 stores response time expended for execution of the reproduction processing corresponding to the record. The response time measurement module 114 measures time from starting of the reproduction processing by the reproduction processing execution module 112 to completion of the reproduction processing as response time of the reproduction processing, and stores the response time in the response time section 1103 after generation of a record corresponding to the reproduction processing.

The setting information table 120 stores setting information of the reproduction processing unit 102 that will affect reproduction processing execution of the reproduction processing execution module 112. The setting information table 120 includes the same setting item as that stored in the setting information table 110 of the reproduction processing storage unit 101. The setting information table 120 includes the same setting item section and setting item value section as that of the setting information table 300 illustrated in FIG. 4.

The reproduction processing management unit 103 manages the reproduction processing unit 102. The reproduction processing management unit 103 determines a reproduction environment enabling execution of the reproduction processing stored in the reproduction processing storage unit 101 from a plurality of the reproduction processing units 102. The reproduction processing management unit 103 also creates a schedule of a reproduction processing executed by the plurality of reproduction processing units 102, or manages a configuration of the reproduction processing units 102.

The reproduction processing management unit 103 includes a reproduction environment determination module 121, a reproduction environment management module 122, a reproduction processing distribution module 123, a schedule management module 124, a resource allocation adjustment module 125, and a storage unit 126.

The reproduction environment determination module 121 determines a reproduction processing unit 102 for executing a reproduction processing received from the reproduction processing storage unit 101. When there is a plurality of reproduction processing units 102, the reproduction environment determination module 121 selects a reproduction environment to prevent an increase of loads caused by simultaneous execution of reproduction processings at one or a plurality of the reproduction processing units 102. The reproduction environment determination module 121 determines a reproduction processing unit 102 for executing the reproduction processing by referring to a system configuration table 129 described below, an environment configuration table 133 described below, a table of restriction on number of reproduction processings 130 descried below, the setting information table 110 received from the reproduction processing storage unit 101, and the setting information table 120 received from the reproduction processing unit 102.

The reproduction environment determination module 121 tests the reproduction processing received from the reproduction processing storage unit 101 in a reproduction processing unit 102 to determine a reproduction processing unit 102 capable of executing the reproduction processing. The reproduction environment determination module 121 determines a reproduction processing unit 102 for reproducing the reproduction processing by comparing the setting information table 110 associated with the reproduction processing received from the reproduction processing storage unit 101 with the setting information table 120 of each reproduction processing unit 102. The above-mentioned processing operation is described below in detail.

The reproduction environment management module 122 manages the reproduction processing unit 102. The reproduction environment management module 122 manages correspondence between the reproduction processing unit 102 and a computer 1801 equipped with the reproduction processing unit 102. The reproduction environment management module 122 manages a relationship between the reproduction processing unit 102 and the computer 1801 equipped with the reproduction processing unit 102 by using the system configuration table 129 described below.

When the computer 1801 equipped with the reproduction processing unit 102 is a virtual server, the reproduction environment management module 122 manages correspondence between the virtual server and a physical server. The physical server is a physical computer 1801, and the virtual server is a virtual computer mounted on the physical server. The reproduction environment management module 122 manages the correspondence between the virtual server and the physical server by the system configuration table 129 described below.

The reproduction environment management module 122 monitors the response time measurement table 119 managed by each reproduction processing unit 102 via the network 1809, and notifies the administrator of degradation of response time when a threshold value stored in the response time threshold value table 131 described below is exceeded.

The reproduction processing distribution module 123 transmits the reproduction processing received from the reproduction processing storage unit 101, the execution schedule of the reproduction processing, and the execution schedule of the reproduction processing in the reproduction processing unit 102 to the reproduction processing unit 102.

The schedule management module 124 determines a schedule of a reproduction processing executed by the reproduction processing unit 102. The schedule management module 124 determines an execution schedule of the reproduction processing received from the reproduction processing storage unit 101 or changes the execution schedule of the reproduction processing in the reproduction processing unit 102. The schedule management module 124 manages a reproduction processing execution schedule table 128 described below, stores the determined schedule in the schedule table 128, and refers to, changes or deletes the schedule of the reproduction processing in the schedule table 128. Scheduling of a reproduction processing over a plurality of the reproduction processing units 102 is described below in detail.

The resource allocation adjustment module 125 adjusts allocation of computer resources of the virtual computer constituting the reproduction processing unit 102. The resource allocation adjustment module 125 requests allocation changing to a hypervisor or a management operation system for controlling resource allocation of the virtual server constituting the reproduction processing unit 102.

The storage unit 126 stores information managed by the reproduction processing management unit 103.

The storage unit 126 includes a reproduction operation table 127, the schedule table 128, the system configuration table 129, the table of restriction on number of reproduction processings 130, a response time threshold value table 131, a setting event correspondence table 132, and the environment configuration table 133. In this embodiment, the reproduction operation table 127, the schedule table 128, the system configuration table 129, the table of restriction on number of reproduction processings 130, the response time threshold value table 131, the setting event correspondence table 132, and the environment configuration table 133 are described as tables. However, the tables are not limited to a table form, and any form may be used for storage as long as pieces of information regarding a reproduction operation, a schedule, a system configuration, a restriction on the number of reproduction processings, a response time threshold value, setting event correspondence, and an environment configuration may be read/written.

The reproduction operation table 127 stores a reproduction processing stored in the reproduction processing storage unit 101. The reproduction processing management unit 103 stores a web transaction stored in the reproduction processing storage unit 101 in the reproduction operation table 127. The reproduction processing management unit 103 receives a reproduction operation table 200 from the reproduction processing storage unit 101, and stores contents of the received reproduction operation table 200 in respective sections of the reproduction operation table 127 of the storage unit 126. The reproduction operation table 127 has the same format as that of the reproduction operation table 200 illustrated in FIG. 2. The reproduction processing management unit 103 generates an identifier for uniquely identifying the received reproduction processing in the reproduction processing management unit 103 to store the generated identifier in the identification section 201. Each record of the reproduction operation table 127 stores each reproduction operation constituting a web transaction.

The schedule table 128 stores an execution schedule of a reproduction processing executed by the reproduction processing unit 102. The schedule table 128 has the same format as that of the schedule table 700 illustrated in FIG. 5.

The system configuration table 129 stores a list of virtual servers constituting the reproduction processing unit 102, correspondence between the virtual server and a physical server constituting the virtual server, and a consumption rate of hardware resources of the physical server occupied by the virtual server.

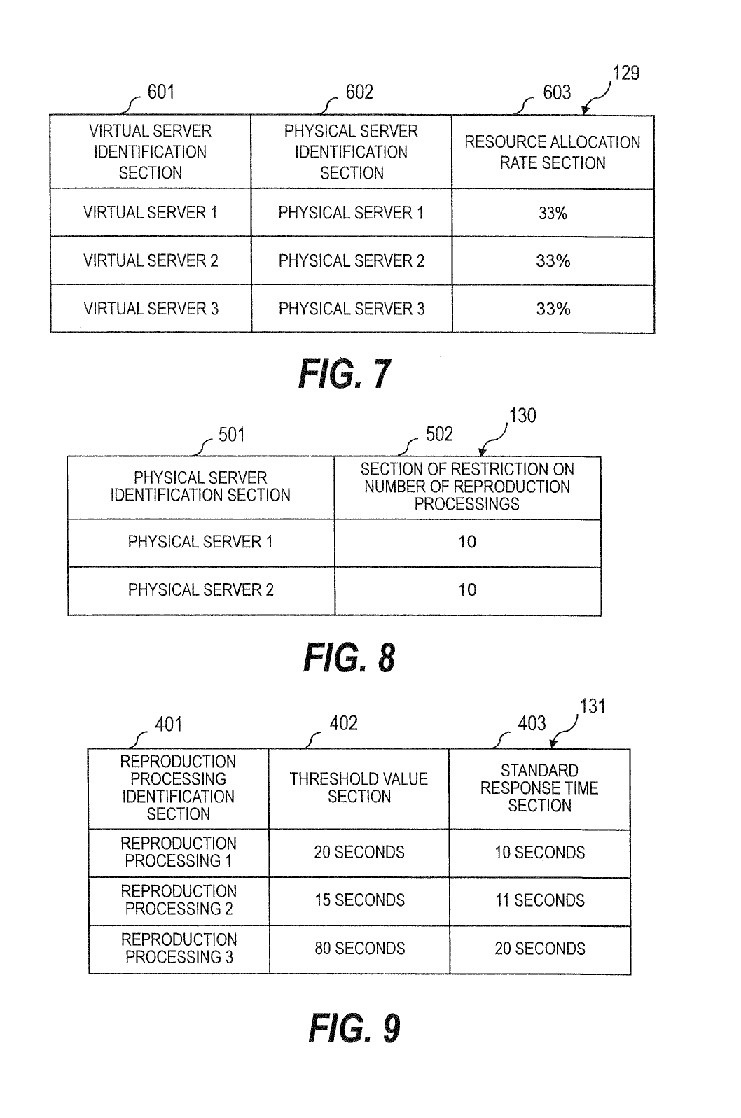

FIG. 7 illustrates the system configuration table 129 according to the first embodiment of this invention.

The system configuration table 129 includes a virtual server identification section 601, a physical server identification section 602, and a resource allocation rate section 603.

The virtual server identification section 601 includes information for identifying a virtual server. The information for identifying a virtual server is not limited to a character string but may be a numeral or a bit string as long as the information uniquely identifies the virtual server.

The physical server identification section 602 includes an identifier for identifying a physical server. The identifier of the physical server identification section 602 is an identifier of a physical server to which the virtual server corresponding to the identifier of the virtual server identification section 601 of each record belongs. The identifier is not limited to a character string and the physical server identification section 602 may include a numeral or a bit string as long as the identifier contains information for uniquely identifying a physical server.

The resource allocation rate section 603 stores a rate of hardware resources allocated to the virtual server corresponding to the identifier of the virtual server identification section 601 of each record among hardware resources of the physical server corresponding to the identifier stored in the physical server identification section 602 of each record. In the resource allocation rate section 603, a fixed value may be set beforehand by the administrator, or a dynamically changed value may be set. In this embodiment, the hardware resources are, for example, a capacity of a main memory 1803, execution time of a CPU 1802, a bandwidth of an external storage interface 1805, and a bandwidth of a communication interface 1806.

The reproduction environment management module 122 generates records of the system configuration table 129 when a reproduction environment constituted by the virtual server is generated. The reproduction environment management module 122 obtains information of the system configuration table 129 from a program of the management operating system or hypervisor for managing the virtual server through the resource allocation adjustment module 125, and stores the obtained information in the virtual server identification section 601, the physical server identification section 602, and the resource allocation rate section 603.

When a change of resource allocation of the virtual server is detected, the reproduction environment management module 122 obtains a resource allocation rate through the resource allocation adjustment module 125 to update the resource allocation rate section 603. The reproduction environment management module 122 also updates the physical server identification section 602 when movement of the virtual server between the physical servers is detected.

The table of restriction on number of reproduction processings 130 stores an upper limit value of the number of executable reproduction processings in the computer 1801 (physical server) constituting the reproduction processing unit 102. The table of restriction on number of reproduction processings 130 stores an identifier of a physical server and an upper limit value of the number of executable reproduction processings on the physical server.

FIG. 8 illustrates the table of restriction on number of reproduction processings 130 according to the first embodiment of this invention.

The table of restriction on number of reproduction processings 130 illustrated in FIG. 8 includes a physical server identification section 501 and a section of restriction on number of reproduction processings 502.

The physical server identification section 501 stores information for identifying a physical server.

The section of restriction on number of reproduction processings 502 stores the number of reproduction processings executable on a physical server corresponding to the physical server identification section 501 of each record. When the number of reproduction processings simultaneously executed on the physical server exceeds the number of executable reproduction processings, loads increase to delay the reproduction processings. The number of executable reproduction processings is a limit value of the number of reproduction processings which causes no delay of the reproduction processings.

Loads of the reproduction processings are generally equal, and hence the number of executable reproduction processings may be calculated from hardware specifications of the physical server. The number of executable reproduction processings may be calculated by testing the reproduction processing on the physical server. The number of executable reproduction processings thus calculated is stored in the section of restriction on number of reproduction processings 502.

The number of executable reproduction processings can be calculated from the hardware specifications of the physical server, and hence the number of executable reproduction processings may be stored beforehand in the table of restriction on number of reproduction processings 130.

The response time threshold value table 131 stores a threshold value of response time measured by the reproduction processing unit 102. Each record of the response time threshold value table 131 stores a threshold value for monitoring a reproduction processing and response time measured by the reproduction processing.

When the response time measured by the response time measurement module 114 of the reproduction processing unit 102 exceeds the value stored in the response time threshold value table 131, the reproduction environment management module 122 notifies the administrator of degradation of response time.

FIG. 9 illustrates the response time threshold value table 131 according to the first embodiment of this invention.

The response time threshold value table 131 includes a reproduction processing identification section 401, a threshold value section 402, and a standard response time section 403.

The reproduction processing identification section 401 stores information for identifying a reproduction processing. When the administrator inputs a threshold value of response time to the computer system of this embodiment, the reproduction processing management unit 103 generates a new record of the response time threshold value table 131 to store the identification information of the reproduction processing designated by the administrator in the reproduction processing identification section 401.

The threshold value section 402 stores a threshold value for monitoring response time measured by executing a reproduction processing of the reproduction processing identification section 401 of each record. The threshold value section 402 illustrated in FIG. 9 stores the number of seconds. When the administrator inputs a threshold value of response time of a reproduction processing to the computer system of this embodiment, the reproduction processing management unit 103 obtains the threshold value of the response time of the reproduction processing input by the administrator to store the threshold value in the threshold value section 402.

The standard response time section 403 stores response time estimated when a reproduction processing of the reproduction processing identification section 401 of each record is executed. The reproduction processing management unit 103 searches for a record where an identifier of the reproduction processing identification section 901 of the reproduction processing table 900 received from the reproduction processing storage unit 101 matches an identifier of the reproduction processing identification section 401 of the response time threshold value table 131 in the reproduction processing table 900, and stores a value of the standard response time section 904 of the record in the standard response time section 403.

The response time threshold value table 131 is used for adjusting an execution schedule of a reproduction processing over a plurality of reproduction processing units 102. The adjustment of the execution schedule of the reproduction processing is described below in a fourth embodiment.

The setting event correspondence table 132 stores correspondence between a setting item and an event log or a window message. Depending on a value of a setting item, the web browser module 104 or the web browser module 113 may generate an event log or a window message.

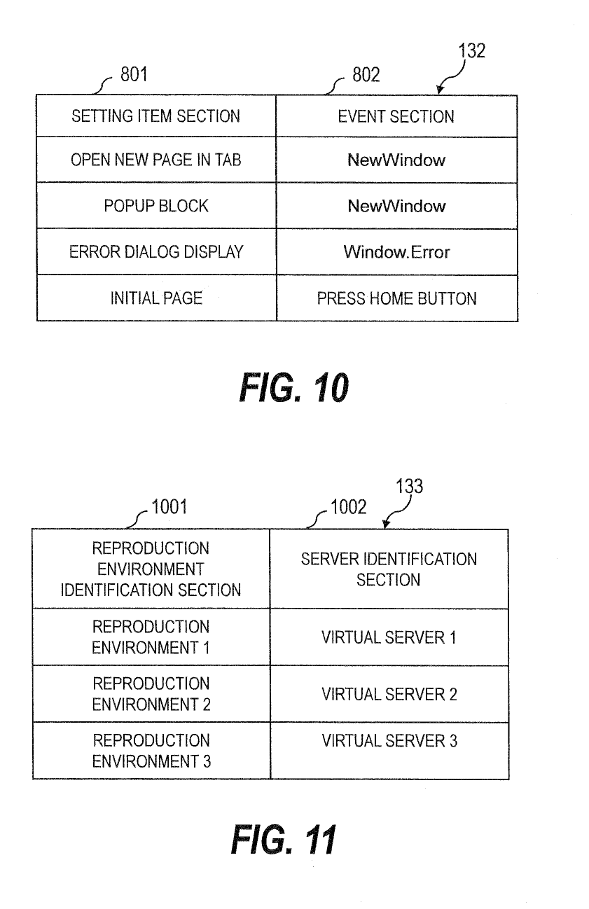

FIG. 10 illustrates the setting event correspondence table 132 according to the first embodiment of this invention.

The setting event correspondence table 132 includes a setting item section 801 and an event section 802.

The setting item section 801 stores identification information indicating an item of setting information.

The event section 802 stores an event log or a window message corresponding to the setting item section 801 of a record. The event log is a log of an event generated from the web browser module 104 of the reproduction processing storage unit 101 or the web browser module 113 of the reproduction processing unit 102. The window message is a window message input to/output from the web browser module 104 and the web browser module 113 or a dialog associated with the web browser module 104 and the web browser module 113.

In the setting event correspondence table 132, information may be stored beforehand by the administrator.

The setting event correspondence table 132, the reproduction operation table 200 and the setting information table 110 received from the reproduction processing storage unit 101, and the setting information table 120 of the reproduction processing unit 102 are used for determining a reproduction processing unit 102 to execute a reproduction processing received from the reproduction processing storage unit 101. The determination of the reproduction processing unit 102 is described below in a second embodiment.

The environment configuration table 133 stores correspondence between the reproduction processing unit 102 and the computer 1801 constituting the reproduction processing unit 102.

FIG. 11 illustrates the environment configuration table 133 according to the first embodiment of this invention.

The environment configuration table 133 includes a reproduction environment identification section 1001 and a server identification section 1002.

The reproduction environment identification section 1001 stores information for identifying the reproduction processing unit 102.

The server identification section 1002 stores information for identifying the computer 1801 constituting the reproduction processing unit 102.

When generating a reproduction processing unit 102, the reproduction processing management unit 103 generates a record of the environment configuration table 133 to store an identifier in the reproduction environment identification section 1001 and the server identification section 1002.

FIG. 12 is a block diagram illustrating a hardware configuration of the computer system according to this embodiment of this invention.

The computer 1801 includes a CPU 1802, a main memory 1803, an external storage interface 1805, a communication interface 1806, an external storage 1804, a network 1809, an input device 1807, and an output device 1808.

The reproduction processing storage unit 101, the reproduction processing unit 102, and the reproduction processing management unit 103 illustrated in FIG. 1 are independent computers installed on the computer 1801. The web browser module 104, the reproduction operation storage module 105, the setting information management module 106, the reproduction processing distribution module 107, the response time measurement module 108, the reproduction processing management module 111, the reproduction processing execution module 112, the web browser module 113, the response time measurement module 114, the setting information management module 115, the reproduction environment determination module 121, the reproduction environment management module 122, the reproduction processing distribution module 123, the schedule management module 124, and the resource allocation adjustment module 125 are stored as programs in the external storage 1804. The programs stored in the external storage 1804 are loaded to the main memory 1803 to be executed by the CPU 1802. The storage unit 109, the storage unit 116, and the storage unit 126 are included in the external storage 1804.

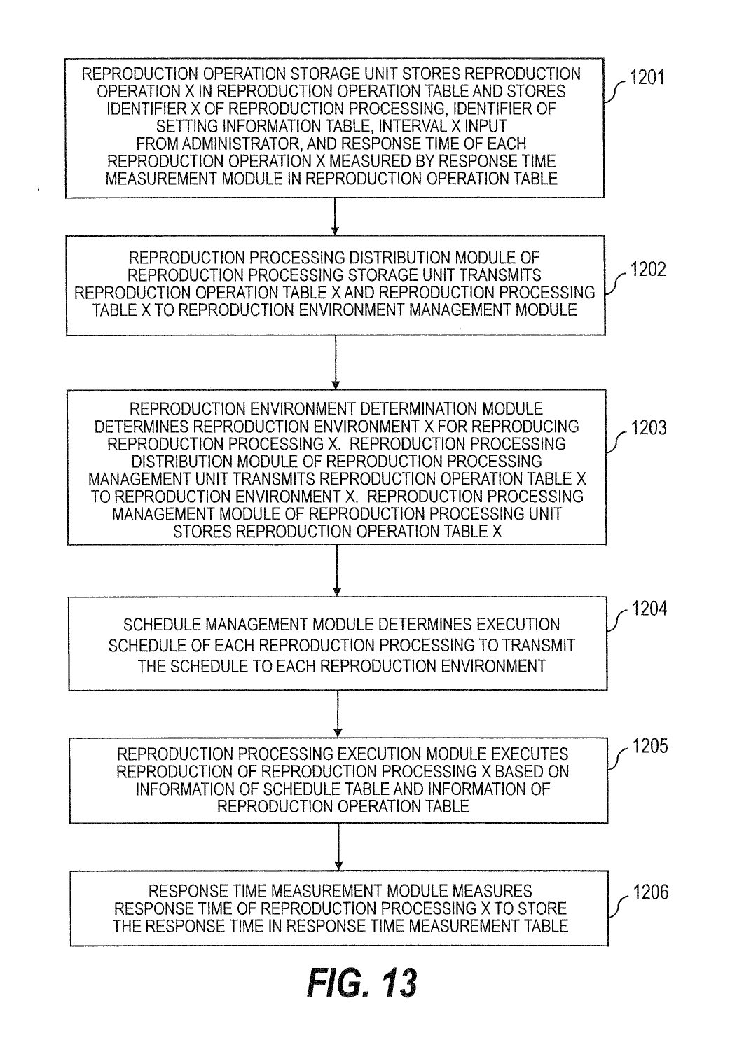

FIG. 13 is a flowchart illustrating overall processing according to the first embodiment of this invention.

(1) The reproduction operation storage module 105 generates, for a reproduction operation X, a reproduction operation table X having the same format as that of the reproduction operation table 200 and a reproduction processing table X having the same format as that of the reproduction processing table 900.

The administrator transmits a storage request message X of a reproduction operation to the reproduction operation storage module 105. The reproduction operation storage module 105 that has received the storage request message generates a new record of a reproduction operation X in the reproduction operation table X. The reproduction operation storage module 105 receives an event log or a window message from the web browser module 104 to sequentially store information of the reproduction operation X in the record. Thereafter, the reproduction operation storage module 105 adds a new record for each reproduction operation X, and stores information designating the reproduction operation X in the section of each record.

After reception of a message of finishing the storage of the reproduction operation X from the administrator, the reproduction operation storage module 105 finishes the operation of storing the reproduction operation X in the reproduction operation table X, and stores a unique identifier X for a series of reproduction operations X from the storage start to the end in the identification section 201. The reproduction operation storage module 105 integrates the series of reproduction operations X into one web transaction X by storing the same identifier X in the identification section 201.

The reproduction operation storage module 105 sets a time interval of executing the web transaction X input beforehand by the administrator as an interval X. The reproduction operation storage module 105 sets response time of the reproduction processing X measured by the response time measurement module 108 as standard response time X. Then, the reproduction operation storage module 105 stores the reproduction processing X, the identifier X of the setting information table 110, the interval X, and the standard response time X respectively in the reproduction processing identification section 901, the setting information identification section 902, the reproduction processing execution interval section 903, and the standard response time section 904 of the reproduction processing table X (Step 1201).

The reproduction processing stored in Step 1201 is referred to as reproduction processing X hereinafter.

(2) The reproduction processing distribution module 107 transmits the reproduction operation table X and the reproduction processing table X to the reproduction environment management module 122 of the reproduction processing management unit 103 (Step 1202).

(3) The reproduction environment determination module 121 determines a reproduction processing unit 102 for reproducing the reproduction processing X. The determined reproduction processing unit 102 is set as a reproduction processing unit X. The reproduction processing distribution module 123 transmits the reproduction operation table X to the reproduction environment X. The reproduction processing management module 111 stores the received reproduction operation table X in the reproduction operation table 117 (Step 1203).

The processing of determining the reproduction processing unit 102 for reproducing and executing the reproduction processing X by the reproduction environment determination module 121 is described below in detail.

(4) The schedule management module 124 determines execution schedule of each reproduction processing X reproduced and executed by the reproduction processing unit 102 to transmit the execution schedule to each reproduction processing unit 102 (Step 1204). The schedule determined in Step 1204 may be only a schedule of the reproduction processing X, or a schedule of a reproduction processing including the reproduction processing X and all or partial reproduction processings other than the reproduction processing X.

The reproduction processing management module 111 that has received the determined schedule stores the determined schedule in the schedule table 118.

The processing of determining the schedule by the schedule management module 124 is described below. Processing of adjusting schedules of the reproduction processing X and a reproduction processing sharing a computer constituting the reproduction processing unit X for reproducing and executing the reproduction processing X by the schedule management module 124 is described below.

Step 1203 may be executed after schedule determination of Step 1204.

(5) The reproduction processing execution module 112 executes the reproduction processing X by using information of the reproduction processing X stored in the schedule table 118 and the reproduction processing X stored in the reproduction operation table 117 (Step 1205).

(6) The response time measurement module 114 measures response time of the reproduction processing X to store the response time in the response time measurement table 119 (Step 1206).

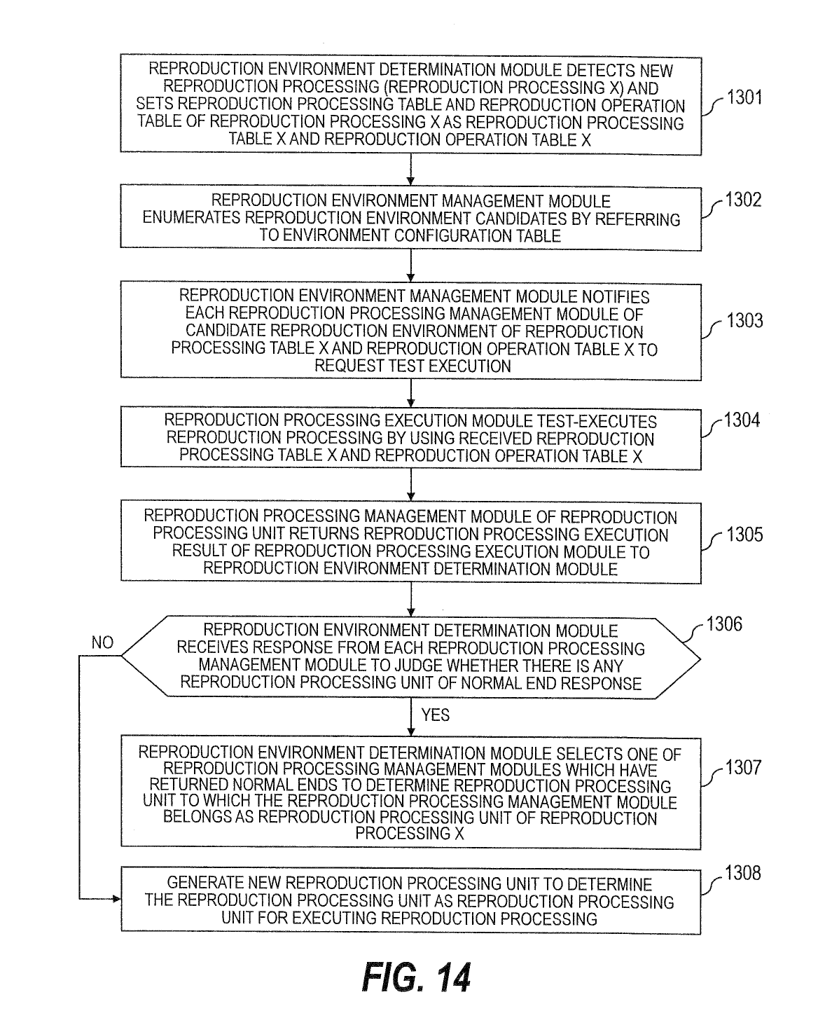

FIG. 14 is a flowchart illustrating processing of executing testing to determine a reproduction environment according to the first embodiment of this invention.

In other words, FIG. 14 is a flowchart illustrating processing in which the reproduction environment determination module 121 tests a received reproduction processing at each reproduction processing unit 102 to determine a reproduction processing unit 102 for executing the reproduction processing among existing reproduction processing units 102. The reproduction processing management unit 103 generates a new reproduction processing unit 102 capable of executing the reproduction processing if there is no reproduction processing unit 102 capable of executing the reproduction processing.

The processing of FIG. 14 may be executed together with the processing of determining the reproduction processing unit 102 in Step 1203 of FIG. 13.

(1) The reproduction environment determination module 121 detects a new reproduction processing (detected reproduction processing is set as reproduction processing X) by receiving a reproduction processing from the reproduction processing storage unit 101 and a reproduction processing from the administrator. The reproduction processing table 900 and the reproduction operation table 200 corresponding to the reproduction processing X are respectively set as a reproduction processing table X and a reproduction operation table X (Step 1301).

(2) The reproduction environment management module 121 enumerates candidates of reproduction processing units 102 by referring to the environment configuration table 133 (Step 1302).

(3) The reproduction environment management module 121 notifies each reproduction processing management module 111 of the reproduction processing units 102 enumerated as candidates of the reproduction processing table X and the reproduction operation table X, and request testing of the reproduction processing X (Step 1303).

(4) The reproduction processing execution module 112 tests the reproduction processing X on the reproduction processing units 102 enumerated in Step 1302 by using the received reproduction processing table X and the received reproduction operation table X (Step 1304).

(5) The reproduction processing management module 111 transmits a reproduction processing execution result of the reproduction processing execution module 112 to the reproduction environment determination module 121 (Step 1305).

(6) The reproduction environment determination module 121 judges whether or not there is any reproduction processing unit 102 whose execution result is a normal end by referring to the reproduction processing execution result received from each reproduction processing management module 111 (Step 1306).

(7) If a judging result of Step 1306 shows that there is a reproduction processing unit 102 which returns a normal end, the reproduction environment determination module 121 selects one of the reproduction processing management modules 111 of the reproduction processing units 102 which have returned normal ends, and determines the reproduction processing unit 102 as a reproduction processing unit 102 of the reproduction operation X (Step 1307).

(8) On the other hand, if a judging result of Step 1306 shows that there is no reproduction processing unit 102 which returns a normal end, the reproduction processing management unit 103 generates a new reproduction processing unit 102, and determines the new reproduction processing unit 102 as a reproduction processing unit 102 for executing the reproduction processing X (Step 1308).

The processing illustrated in FIG. 14 enables selection of a reproduction environment X capable of surely reproducing and executing the reproduction processing X to actually test the reproduction processing X in the reproduction processing unit 102. Even if setting information of the reproduction processing storage unit 101 recording the reproduction processing X and setting information of the reproduction processing unit 102 are partially different from each other, the reproduction processing unit 102 can be determined as a reproduction environment X. The reproduction environment X can be determined without comparing setting information with another. The reproduction processing is tested before response time measurement, and hence whether or not the reproduction processing is executable can be judged beforehand.

In the processing of FIG. 14, the reproduction processing X is tested by the existing reproduction processing unit 102. Not limited to this, however, in the case of testing, the reproduction processing management unit 103 may generate a new reproduction processing unit 102 of the same environment as that of the existing reproduction processing unit 102, the new reproduction processing unit 102 may test the reproduction processing X, and a testing result may be returned as a testing result of the existing reproduction processing unit 102 to the reproduction environment determination module 121. Thus, the reproduction environment determination module 121 can obtain a testing result of the reproduction processing X without affecting the other reproduction processing being executed in the existing reproduction processing unit 102. For example, when the reproduction processing unit 102 includes a virtual server, the new reproduction processing unit 102 may generate a copy of the virtual server for itself, and execute the reproduction processing X on the virtual server of the copying destination.

The computer system of the first embodiment has been described as the web system. Not limited to this, however, any computer system may be employed. For example, the computer system may be a batch processing system or an on-line transaction system.

### Second Embodiment

In a second embodiment of this invention, a reproduction processing management unit 103 determines a reproduction processing unit 102 for executing a reproduction processing among existing reproduction processing units 102 by using setting information of a reproduction processing storage unit 101 and a reproduction processing unit 102 and an event log or a window message log generated when the reproduction processing storage unit 101 records a reproduction processing.

A configuration of a computer system of the second embodiment is the same as that of the block diagram illustrated in FIG. 1.

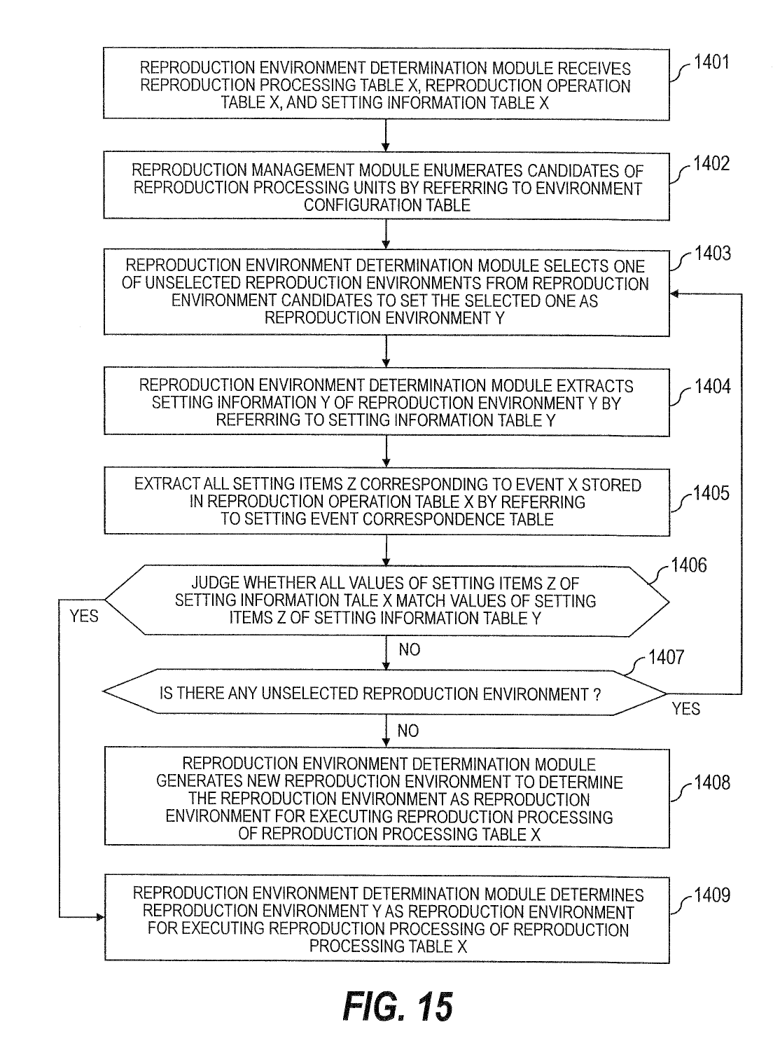

FIG. 15 is a flowchart illustrating a determination processing of a reproduction environment using setting information and event information according to the second embodiment of this invention.

The processing illustrated in FIG. 15 may be executed together with the determination processing of the reproduction processing unit 102 in Step 1203 of FIG. 13.

(1) The reproduction environment determination module 121 receives a reproduction processing table X, a reproduction operation table X, and a setting information table X corresponding to a reproduction processing X stored in the reproduction processing unit 101 (Step 1401).

(2) The reproduction environment management module 122 enumerates candidates of reproduction processing units 102 by referring to the environment configuration table 133 (Step 1402).

(3) The reproduction environment determination module 121 selects one of unselected reproduction processing units 102 from among the candidates of the reproduction processing units 102 enumerated in Step 1402 to set the selected one as a reproduction environment Y (Step 1403).

(4) The reproduction environment determination module 121 extracts setting information Y of the reproduction environment Y by referring to a setting information table 120 (setting information table Y) of the reproduction environment Y (Step 1404). The setting information table 120 may be transmitted beforehand from the reproduction processing unit 102.

(5) The reproduction environment determination module 121 extracts all setting items Z corresponding to an event X of an event section stored in a reproduction operation table X by referring to a setting event correspondence table 132 (Step 1405).

The reproduction environment determination module 121 extracts all events X stored in the event section 206 of the reproduction operation table 200. The reproduction environment determination module 121 searches for records in which the events X match the event section 802 of the setting event correspondence table 132, and enumerate all setting items stored in the setting item section 801 (setting items Z).

(6) The reproduction environment determination module 121 judges whether or not values of all the setting items Z of the setting information table X match values of setting items Z of the setting information table Y (Step 1406).

The reproduction environment determination module 121 compares setting information of the reproduction processing storage unit 101 with that of the reproduction processing unit 102 only for the setting items Z enumerated in Step 1405. When at least one setting item is not matched, the reproduction environment determination module 121 presumes that the reproduction processing X cannot be executed in the unmatched reproduction processing unit 102.

(7) If a judging result of Step 1406 shows that all the setting items match, the reproduction environment determination module 121 determines the reproduction processing unit Y as a reproduction processing unit 102 for executing the reproduction processing X (Step 1409).

(8) If a judging result of Step 1406 shows that at least one setting item is not matched, the reproduction environment determination module 121 judges whether or not there is any unselected reproduction processing unit 102 by referring to the environment configuration table 133 (Step 1407).

If a judging result of Step 1407 shows that there is an unselected reproduction processing unit 102, the processing illustrated in FIG. 15 returns to Step 1403 (Step 1407).

(9) If a judging result of Step 1407 shows that there is no unselected reproduction processing unit 102, the reproduction environment determination module 121 generates a new reproduction processing unit 102, and determines the newly generated reproduction processing unit 102 as a reproduction processing unit 102 for executing the reproduction processing X (Step 1408).

After the reproduction environment determination module 121 has generated a new reproduction processing unit 102, the reproduction environment determination module 121 stores information of the new reproduction processing unit 102 in the system configuration table 129 and the environment configuration table 133.

The computer system of the second embodiment has been described as the web system. Not limited to this, however, any computer system may be employed. For example, the computer system may be a batch processing system or an on-line transaction system.

As described above, according to the second embodiment, even when there is a difference between setting information of the reproduction processing storage unit 101 and setting information of the reproduction processing unit 102 among the setting items not affecting the reproduction processing X, the reproduction processing unit 102 can be determined as a reproduction processing unit 102 of the reproduction processing X. A reproduction processing unit 102 for executing the reproduction processing X can be determined without affecting the other reproduction processing being executed in the reproduction processing unit 102.

### Third Embodiment

In a third embodiment of this invention, control for enabling a reproduction processing management unit 103 to schedule a reproduction processing over a plurality of reproduction processing units 102 and to simultaneously execute reproduction processings without increasing loads is described.

A configuration of a computer system of the third embodiment is similar to that of the block diagram of FIG. 1.

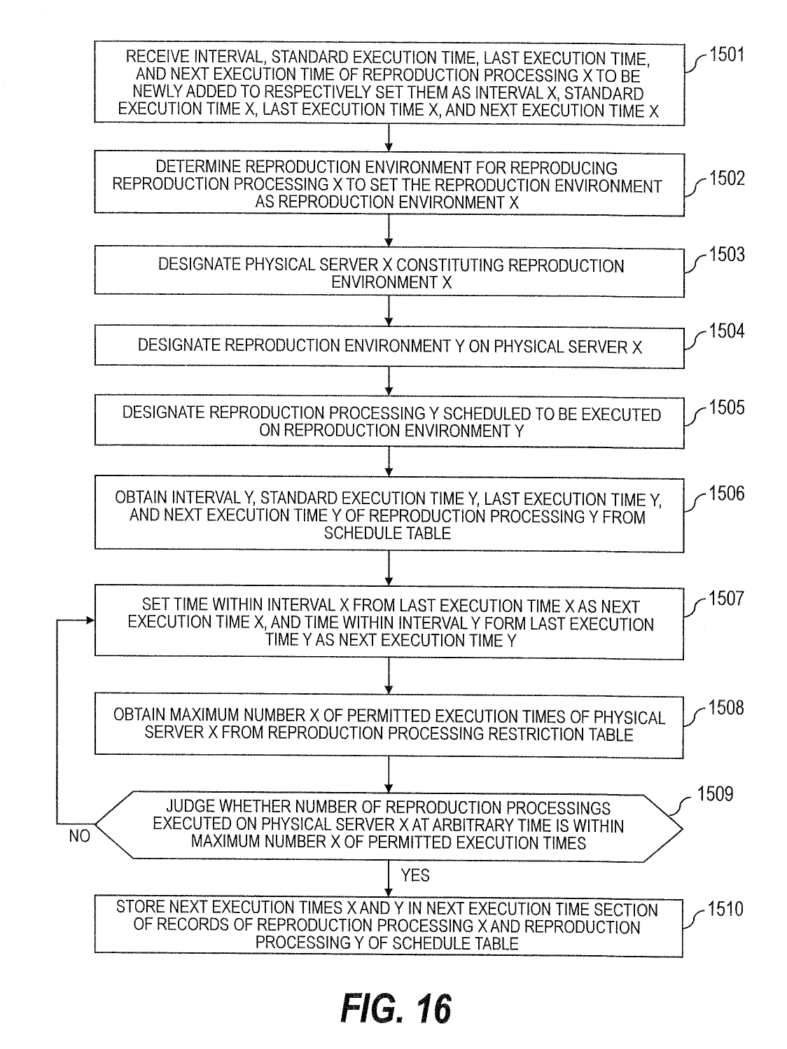

FIG. 16 is a flowchart illustrating a scheduling processing over reproduction environments according to the third embodiment of this invention.

The processing illustrated in FIG. 16 may be executed together with the processing of transmitting an execution schedule of a reproduction processing to the reproduction processing unit 102 in Step 1204 of FIG. 13.

(1) The reproduction environment management module 122 receives the reproduction processing table 900 and the reproduction operation table 200 from the reproduction processing storage unit 101, and receives an interval X, standard execution time X, last execution time X, and next execution time X of a newly added reproduction processing X (Step 1501).

(2) The reproduction environment determination module 121 determines a reproduction environment for reproducing the reproduction processing X to set the reproduction environment as a reproduction environment X (Step 1502). A method of determining a reproduction environment is similar to those of the first and second embodiments.

(3) The reproduction environment determination module 121 designates, when the reproduction processing X is executed in the reproduction environment X, a reproduction processing Y which cannot be normally executed due to sharing resources of a physical server X.

(3-1) The reproduction environment determination module 121 designates, to designate a reproduction environment for sharing resources of the physical server X with the reproduction environment X, a physical server X constituting the reproduction environment X (Step 1503). The reproduction environment determination module 121 designates a virtual server X corresponding to the reproduction environment X and a physical server X including the virtual server X by referring to the system configuration table 129 and the environment configuration table 133.

Specifically, the reproduction environment determination module 121 searches for a record in which the reproduction environment identification section 1001 matches the reproduction environment X by referring to the environment configuration table 133. Then, the reproduction environment determination module 121 sets a virtual server identified by a value of the server identification section 1002 of the matched record as a virtual server X. The reproduction environment determination module 121 searches for a record in which the virtual server identification section 601 matches the virtual server X by referring to the system configuration table 129. The reproduction environment determination module 121 sets a physical server identified by a value of the physical server identification section 602 of the matched record as a physical server X.

(3-2) To designate a reproduction environment that shares resources of the physical server X with the reproduction environment X, the reproduction environment determination module 121 designates a reproduction environment Y on the physical server X designated in Step 1503 (Step 1504). The reproduction environment determination module 121 enumerates virtual servers Y on the physical server X to designate a reproduction environment Y corresponding to the virtual servers Y by referring to the system configuration table 129 and the environment configuration table 133.

Specifically, the reproduction environment determination module 121 searches for a record in which a value of the physical server identification section 602 matches the physical server X by referring to the system configuration table 129. Values of the virtual server identification section 601 of all the matched records are set as virtual servers Y. Then, the reproduction environment determination module 121 searches for a record in which the server identification section 1002 matches the virtual server Y by referring to the environment configuration table 133. The reproduction environment determination module 121 sets a value of the reproduction environment identification section 1001 of the matched record as a reproduction environment Y.

The reproduction environment X and the searched reproduction environment Y are reproduction processing units 102 in which all the reproduction environments Y are configured on the same physical server X, and reproduction processings executed in the respective environments compete with each other for hardware resources of the physical server X.

(3-3) The reproduction environment determination module 121 designates a reproduction processing Y scheduled to be executed in the reproduction environment Y (Step 1505). There is a possibility that the designated reproduction processing Y will conflict with a newly added reproduction processing X for resources of the physical server X. The reproduction processing Y is not limited to one. A plurality of reproduction processings Y may be executed as long as they share resources of the physical server X.

The schedule management module 124 enumerates reproduction processings Y operated in the reproduction environment Y by referring to the reproduction processing execution schedule table 128.

Specifically, the schedule management module 124 searches for a record of the reproduction environment identification section 702 matched with the reproduction processing Y by referring to the reproduction processing schedule table 700. The schedule management module 124 sets values of the reproduction processing identification section 701 of all the matched records as reproduction processings Y.

(4) The schedule management module 124 selects execution schedule candidates of a reproduction processing X and a reproduction processing Y so that a reproduction execution time interval of each of the reproduction processing X and the reproduction processing Y can be within administrator's monitoring interval.

(4-1) The schedule management module 124 obtains schedule information from all the reproduction processings Y from the schedule table 128 (Step 1506).

Specifically, the schedule management module 124 searches for a record of the reproduction processing identification section 701 matched with the reproduction processing Y by referring to the schedule table 700. The schedule management module 124 sets values of the interval section 703, the standard response time section 704, and the last execution time 705 of the matched record respectively as an interval Y, standard response time Y, and last execution time Y.

(4-2) The schedule management module 124 determines next execution time of a reproduction processing X and a reproduction processing Y which satisfies the monitoring interval of administrator's response time monitoring (Step 1507). If next execution time cannot be determined, rescheduling fails and the processing of the third embodiment is finished.

Specifically, the schedule management module 124 determines next execution time X within time of the interval X from the last execution time X, and next execution time Y within time of the interval Y from the last execution time Y.

(5) The schedule management module 124 judges, when the reproduction processing X and the reproduction processing Y are executed in the physical server X, whether or not the number of resources of the physical server X used by the reproduction processing X and the reproduction processing Y at arbitrary time is within the number of restricted execution times of the physical sever X.

(5-1) The schedule management module 124 obtains the maximum number X of permitted execution times of the physical server X from the table of restriction on number of reproduction processings 130 (Step 1508).

Specifically, the schedule management module 124 searches for a record in which the physical server identification section 501 matches the physical server X by referring to the table of restriction on number of reproduction processings 130. The schedule management module 124 sets a value of the section of restriction on number of reproduction processings 502 of the matched record as a maximum number X of permitted execution times.

The maximum number X of permitted execution times is the number of reproduction processings executable in the physical server X. When a total of the number of reproduction processings executed by a plurality of reproduction processing units 102 configured in the physical server X exceeds the number of permitted execution times X, loads on the physical server X increase to disable a normal operation of the physical server X.

(5-2) The schedule management module 124 judges whether or not the number of reproduction processings executed in the physical server X at arbitrary time is within the maximum number X of permitted execution times (Step 1509).

Specifically, the schedule management module 124 judges, when a reproduction processing X is executed for standard response time X from next execution time X and a reproduction processing Y is executed for standard response time Y from next execution time Y, whether or not a total number of reproduction processings being executed at arbitrary time is within the maximum number X of permitted execution times.

(6) If a judging result of Step 1509 shows that the total number of executed reproduction processings is within the number of restricted execution times, the schedule management module 124 determines that the reproduction processing X and the reproduction processing Y are executed according to execution schedules of the reproduction processing X and the reproduction processing Y. The schedule management module 124 updates the next execution time section 706 of the records of the reproduction processing X and the reproduction processing Y of the reproduction processing execution table 700 (Step 1510).

Specifically, the schedule management module 124 searches, by referring to the reproduction processing execution schedule table 700, for a record in which the reproduction processing identification section 701 matches the reproduction processing X to store time X in the next execution time section 706 of the record. The schedule management module 124 searches, by referring to the reproduction processing execution schedule table 700, for a record in which the reproduction processing identification section 701 matches the reproduction processing Y to store time Y in the next execution time section 706 of the record.

If a judging result of Step 1509 shows that the number of executed reproduction processings is not within the restricted number of execution times X, the processing illustrated in FIG. 16 returns to Step 1507 to determine a schedule again.

According to the above-mentioned third embodiment, the reproduction processings sharing the resources of the physical server are enumerated. However, shared resources are not limited to hardware resources of the physical server. Any resources shared by reproduction processings may be used. For example, the reproduction processings may share a band of the network 1809, a storage band, or a storage capacity.

The computer system of the third embodiment has been described as the web system, but is not limited to the web system, and any computer system may be employed. For example, the computer system may be a batch processing system or an on-line transaction system.

In the third embodiment, the schedule management module 124 shifts the execution time within the time interval to adjust the schedule. However, the method of adjusting the schedule is not limited thereto, and the schedule management module 124 may adjust any value to adjust the schedule.

The method of adjusting the schedule described in the third embodiment is only exemplary, and is in no way limitative of this invention. For example, the schedule management module 124 may calculate a passage of time from the last execution time for each reproduction processing, and adjust, by using time obtained by calculating time obtained by subtracting the passage of time from the interval for each reproduction processing, the schedule by a method of setting higher priority in order of shorter obtained time.

In the third embodiment, the schedule management module 124 adjusts the schedule when a new reproduction processing is generated. However, the timing for adjusting the schedule is not limited thereto, and the schedule may be adjusted at any timing. For example, the schedule management module 124 may adjust reschedule when the schedule management module 124 detects exceeding of the maximum number X of permitted execution times at certain time due to delaying of a given reproduction processing.

In the third embodiment, the schedule management module 124 calculates next execution time of each reproduction processing as the scheduling method. However, the scheduling method is not limited thereto, and any scheduling method may be used. If the reproduction processing management unit 103 is configured to provide a token permitting reproduction execution to each reproduction processing unit 102, the schedule management module 124 may adjust the execution schedule of a reproduction processing over a plurality of reproduction environments in a manner that the reproduction processing management unit 103 provides a token to each reproduction processing unit 102 so as not to exceed the maximum number X of permitted execution times.

In the third embodiment, the schedule management module 124 may adjust the schedule by, for example, a method in which the reproduction processing unit 102 autonomously transmits an execution request of a reproduction processing to the reproduction processing management unit 103, the reproduction processing management unit 103 returns execution permission of the reproduction processing to the reproduction processing unit 102 which has made the request within a range not exceeding the maximum number X of permitted execution times, and the reproduction processing unit 102 which has received the response executes the reproduction processing.

In the third embodiment, the schedule management module 124 adjusts the schedule over the plurality of reproduction environments by a reproduction processing unit, but the method of adjusting the schedule is not limited thereto. For example, the execution schedule may be adjusted by a reproduction operation unit constituting a reproduction processing in place of the reproduction processing unit.

According to the above-mentioned third embodiment, the computer system can prevent delaying of a reproduction processing caused by an increase of loads which occurs due to simultaneous execution of reproduction processings in the plurality of reproduction processing units 102 while securing an appropriate time interval for the execution of reproduction processings in the plurality of reproduction processing units 102. When a plurality of reproduction environments (virtual servers) is configured on the same physical server, an increase in loads on the physical server can be suppressed by adjusting the schedule over the plurality of reproduction environments and reducing the number of simultaneously executed reproduction processings.

According to the third embodiment, response time can be measured without being affected by a load state of the measured physical server. For example, if loads on the measured physical server side are high, rendering time of the browser is delayed. The rendering sets a status in which the user can browse the data by the browser. According to the conventional technology, when response time including rendering time of the browser is measured, it is not allowed to judge which of a page referred to and high loads on the measured physical server side a cause of a delay of rendering time of the browser is. According to the third embodiment, however, if a status in which an increase in loads on the physical server can be prevented and, if a delay of response time and a delay of rendering time can be designated, whether or not a page referred to is a problem can be judged without considering loads on the physical server.

### Fourth Embodiment

In a fourth embodiment of this invention, a processing in which when execution of a reproduction processing conflicts with another reproduction processing, a reproduction processing management unit executes scheduling to put priority on a reproduction processing having a threshold value of response time set severe is described.

A configuration of a computer system of the fourth embodiment is similar to the configuration of the block diagram of FIG. 1.

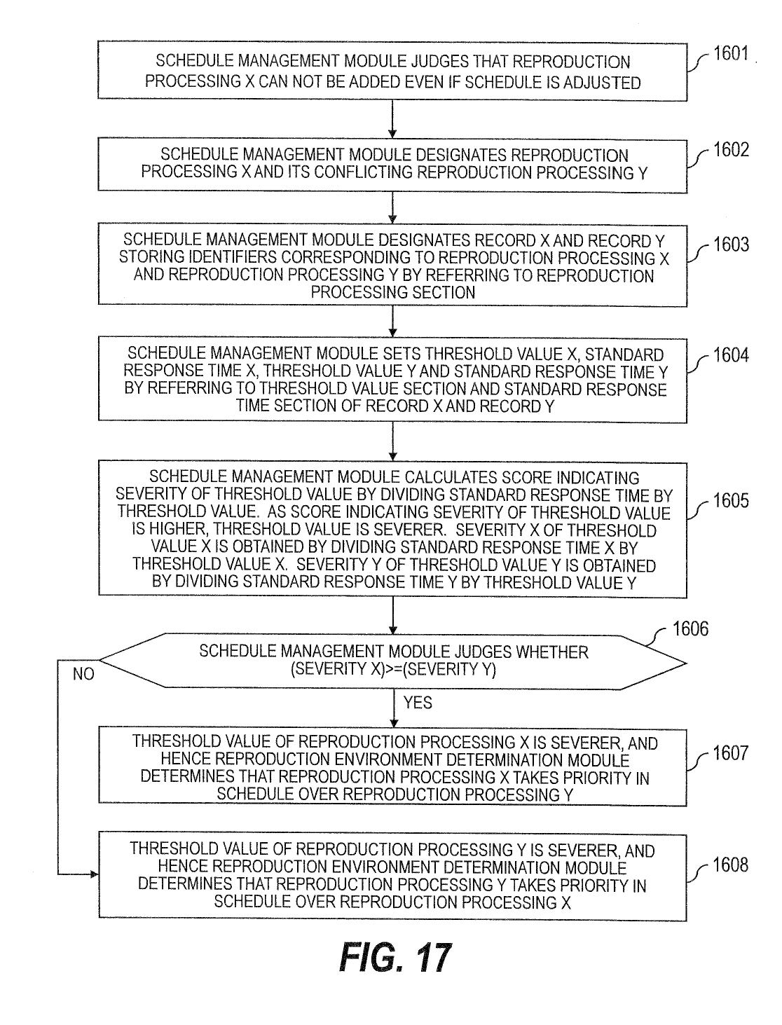

FIG. 17 is a flowchart illustrating priority scheduling with a severity of a threshold value of response time in the fourth embodiment of this invention taken into consideration.

The processing illustrated in FIG. 17 may be executed together with the processing of transmitting the execution schedule of the reproduction processing to the reproduction processing unit 102 in Step 1204 of FIG. 13.

(1) A schedule management module 124 judges that a reproduction processing X cannot be added even if a schedule is adjusted (Step 1601).

(2) The schedule management module 124 designates reproduction processing Y that conflicts with the reproduction processing X (Step 1602).

“The reproduction processing Y conflicts with the reproduction processing X” means that the reproduction processing X and the reproduction processing Y cannot be simultaneously scheduled in Step 1507 of the third embodiment but can be scheduled if only one of the reproduction processing X and the reproduction processing Y is included in a schedule while the other is not included.

(3) The schedule management module 124 designates a record X and a record Y storing identifiers corresponding to the reproduction processing X and the reproduction processing Y by referring to the reproduction processing identification section 401 of the response time threshold value table 131 (Step 1603).

(4) The schedule management module 124 refers to the threshold value section 402 and the standard response time section 403 of the record X and the record Y, set a value of the threshold value section 402 of the record X as a threshold value X, set a value of the standard response time section 403 of the record X as a standard response time X, set a value of the threshold value section 402 of the record Y as a threshold value Y, and set a value of the standard response time section 403 of the record Y as a standard response time Y (Step 1604).

(5) The schedule management module 124 calculates a score indicating a severity of a threshold value. In the fourth embodiment, the schedule management module 124 calculates a severity by dividing standard response time by a threshold value. In other words, a severity X of the threshold value X is a result of dividing the standard response time X by the threshold value X. A severity Y of the threshold value Y is a result of dividing the standard response time Y by the threshold value Y. The scores indicating severities of the threshold values thus obtained are judged to be severer as numerical values are larger (Step 1605).

(6) The schedule management module 124 judges whether or not (severity X)>=(severity Y) is established (Step 1606).

(7) If a judging result of Step 1606 shows (severity X)>=(severity Y), the threshold value of the reproduction processing X is severer, and hence the schedule management module 124 determines that the reproduction processing X takes priority in scheduling over the reproduction processing Y (Step 1607).

(8) If a judging result of Step 1606 shows (severity X)<(severity Y), the threshold value of the reproduction processing Y is severer, and hence the schedule management module 124 determines that the reproduction processing Y takes priority in scheduling over the reproduction processing X (Step 1608).

As described above, according to the fourth embodiment, even when the reproduction processing executed in the reproduction processing unit 102 conflicts with another reproduction processing, a reproduction processing to be preferentially executed can be determined. Even in the environment of sharing hardware resources of the physical server, scheduling can be performed to enable execution of a plurality of reproduction processings without increasing loads. The reproduction processing having a severe threshold value set therein is a web system of a high response time request, and a necessity of preferential monitoring is frequently high. In other words, the administrator can preferentially monitor a web system of a high monitoring request.

In the fourth embodiment, the two processings, i.e., the reproduction processing X and the reproduction processing Y, are simultaneously scheduled. However, even when three or more reproduction processings are simultaneously scheduled, an order of priority is determined through the same procedure.

The computer system of the fourth embodiment has been described as the web system. However, the computer system is not limited to the web system, and any computer system may be employed. For example, the computer system may be a batch processing system or an on-line transaction system.

In the fourth embodiment, the severity of the threshold value is calculated by dividing the standard response time when the reproduction processing is stored by the threshold value. However, the method of calculating the severity of the threshold value is not limited thereto, and any method may be used for calculation. For example, when a reproduction processing is recorded, response time may be measured several times, and the reproduction processing whose rate of exceeding the threshold value is large among the measured response times may be judged to be a reproduction processing of a severe threshold value.

The severity of the threshold value of the reproduction processing executed in the reproduction processing unit 102 may be calculated by using the response time measured by the reproduction processing unit 102. For example, the severity of the threshold value may be calculated by dividing the response time measured in the reproduction processing unit 102 by the threshold value, or the response time of the reproduction processing may be measured several times in the reproduction processing unit 102, and the reproduction processing whose rate of exceeding the threshold value is large among the measured response times may be judged to be severe in threshold value. Severities of threshold values may be compared with each other by using a threshold exceeding rate during recording for a newly added reproduction processing and a threshold exceeding rate using response time of the reproduction processing unit 102 for an executed reproduction processing of the reproduction processing unit 102.

### Fifth Embodiment

In a fifth embodiment of this invention, description is made of a processing for increasing the number of reproduction processings simultaneously executed in a physical server constituting a virtual server by sharing hardware resources allocated among virtual servers constituting a reproduction processing unit 102.

A configuration of a computer system of the fifth embodiment is similar to the configuration of the block diagram of FIG. 1.

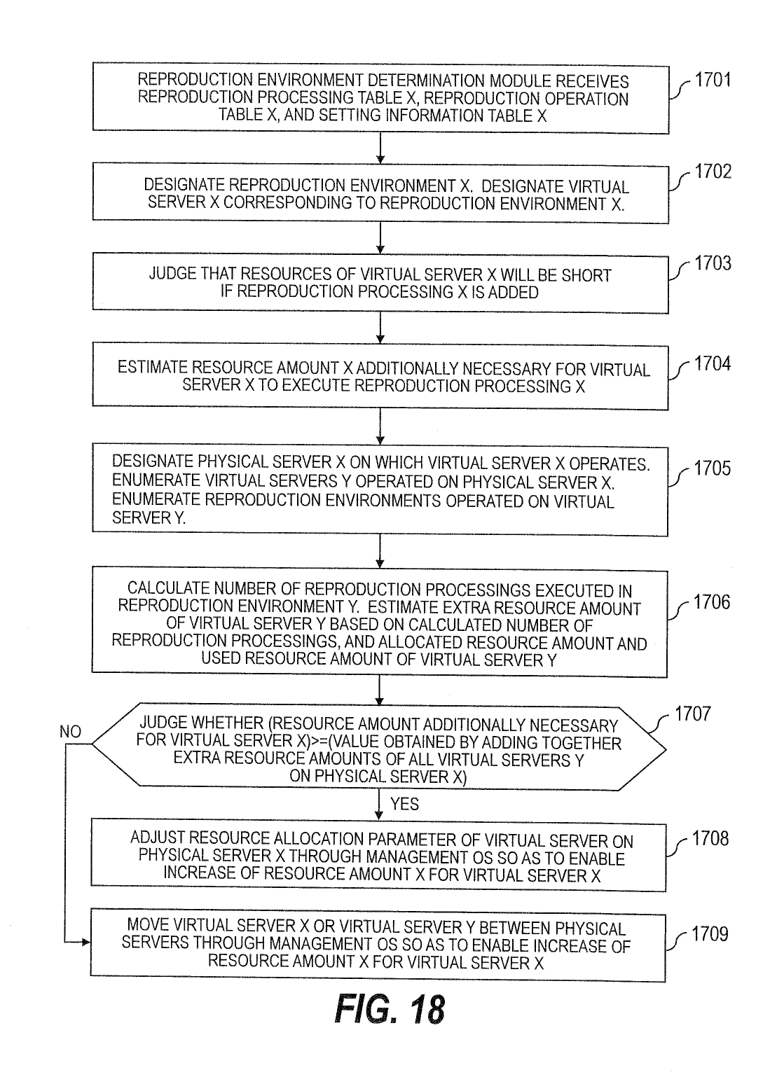

FIG. 18 is a flowchart illustrating control of simultaneous execution by distribution of resources among reproduction environments according to the fifth embodiment of this invention.

In the fifth embodiment, an administrator has means for measuring the amount of resources allocated to the virtual server, the amount of resources needed by the virtual server, and the amount of resources short in the virtual server when a reproduction processing is executed. The means for measuring the amount of resources may be means for measuring by a reproduction processing management unit 103, means for measuring by a reproduction processing unit 102, or means for inputting the amount of resources by the administrator.

(1) A reproduction environment determination module 121 receives a reproduction processing table X, a reproduction operation table X, and a setting information table X designating a reproduction processing X from a reproduction processing storage unit 101 (Step 1701).

(2) The reproduction environment determination module 121 determines a reproduction processing unit 102 for executing the reproduction processing X as a reproduction environment X. The reproduction environment determination module 121 sets a computer 1801 constituting the reproduction environment X as a virtual server X (Step 1702).

(3) The reproduction environment determination module 121 calculates, when the reproduction processing X is executed by the reproduction processing unit X, a shortage amount from a difference between the amount of resources needed by the virtual server and the amount of resources allocated to the virtual server, and judges a shortage of resources of the virtual server X if there is a predetermined shortage amount (Step 1703). If resources are not short, the processing of the fifth embodiment is finished.

(4) The reproduction environment determination module 121 calculates an amount of resources X needed to be added to the virtual server X for executing the reproduction processing X (Step 1704).

(5) The reproduction environment determination module 121 designates a physical server on which the virtual server X operates. The reproduction environment determination module 121 enumerates virtual servers Y operated on the physical server X by referring to a system configuration table 129. The reproduction environment determination module 121 enumerates reproduction environments Y operated on the virtual server Y by referring to an environment configuration table 133 (Step 1705).

(6) The reproduction environment determination module 121 calculates the number of reproduction processings executed in the reproduction environment Y. The reproduction environment determination module 121 calculates the amount of unused resources of the virtual server Y from the calculated number of reproduction processings and the amount of allocated resources and the amount of used resources of the virtual server Y (Step 1706). The reproduction environment determination module 121 calculates a value totaling the amounts of extra resources of all the virtual servers Y on the physical server X.

(7) The reproduction environment determination module 121 judges whether “the amount of resources to be added to the virtual server X” calculated in Step 1704 is equal to or more than “the value obtained by totaling the amounts of extra resources of all the virtual servers Y on the physical server X” calculated in Step 1706 (Step 1707).

(8) If a judging result of Step 1707 shows that “the amount of resources to be added to the virtual server X” is equal to or more than “the value obtained by totaling the amounts of extra resources of all the virtual servers Y on the physical server X”, a resource allocation adjustment module 125 adjusts resource allocation parameters of the virtual servers on the physical server X through a management operating system or a hypervisor so as to add the amount of resources X to the virtual server X (Step 1708).

The adjustment of the resource allocation parameters increases an allocation amount of hardware resources to the virtual server X, to thereby increase the number of reproduction processings executable on the virtual server.

(9) If a judging result of Step 1707 shows that “the amount of resources to be added to the virtual server X” is a value lower than “the value obtained by totaling the amounts of extra resources of all the virtual servers Y on the physical server X”, the resource allocation adjustment module 125 allocates a physical server to the virtual server X or the virtual server Y through the management operating system or the hypervisor so as to increase the amount of resources X for the virtual server X (Step 1709).

As described above, according to the computer system of the fifth embodiment, the number of reproduction processings simultaneously executable on the reproduction processing unit 102 can be increased or decreased. The computer system of the fifth embodiment can add a reproduction processing without rescheduling an existing reproduction processing. The computer system of the fifth embodiment can increase the number of reproduction processings to be simultaneously executed. The computer system of the fifth embodiment needs no complex schedule adjustment, and can partially entrust execution timing to a resource allocation processing of the hypervisor or the management operating system for managing the virtual server.

The computer system of the fifth embodiment has been described as the web system. However, the computer system is not limited to the web system, and any computer system may be employed. For example, the computer system may be a batch processing system or an on-line transaction system.

While the present invention has been described in detail and pictorially in the accompanying drawings, the present invention is not limited to such detail but covers various obvious modifications and equivalent arrangements, which fall within the purview of the appended claims.

What is claimed is:

1. A reproduction processing method of reproducing user's operation of a computer system which includes at least one processor for executing a program and a memory coupled to the at least one processor,
the processor being configured to realize a storage processing unit for storing user's operation of the computer system, at least one reproduction unit for reproducing the user's operation, and a management unit for managing a schedule of the reproduction by executing the program,
the reproduction processing method comprising:
storing, by the storage processing unit, contents of the user's operation;
transmitting, by the storage processing unit, the stored contents of the user's operation to the management unit;
determining, by the management unit, a reproduction unit of the at least one reproduction unit for executing a reproduction processing according to the contents of the user's operation;
determining, by the management unit, a schedule of executing the reproduction processing;
transmitting, by the management unit, the stored contents of the user's operation and the determined schedule to the determined reproduction unit; and
executing, by the determined reproduction unit, the reproduction processing based on the received contents of the user's operation and the schedule.

2. The reproduction processing method according to claim 1, comprising:
selecting, by the management unit, at least one reproduction unit as a candidate for executing the reproduction processing from the at least one reproduction unit;
transmitting, by the management unit, the stored contents of the user's operation to the selected at least one reproduction unit;
executing, by the selected at least one reproduction unit, the reproduction processing based on the received contents of the user's operation;
returning, by the selected at least one reproduction unit, an execution result of the reproduction processing to the management unit; and
determining, by the management unit, the reproduction unit for executing the reproduction processing.

3. The reproduction processing method according to claim 1, comprising:
obtaining, by the management unit, first setting information indicating setting of the storage processing unit when the contents of the user's operation stored in the storage processing unit are operated;
obtaining, by the management unit, second setting information indicating setting of the at least one reproduction unit when the contents of the user's operation stored in the storage processing unit are operated;
comparing, by the management unit, the obtained first setting information with the obtained second setting information; and
determining, by the management unit, the reproduction unit for executing the reproduction processing based on a comparison result of the first setting information and the second setting information.

4. The reproduction processing method according to claim 1, wherein:
the reproduction processing includes at least one first reproduction processing and at least one second reproduction processing different from the at least one first reproduction processing; and
the reproduction processing method comprises:
determining, by the management unit, a reproduction unit for executing the at least one first reproduction processing;
designating, by the management unit, second reproduction processings executed by the reproduction unit for executing the at least one first reproduction processing;
obtaining, by the management unit, a maximum number of reproduction processings executable by the reproduction unit; and
creating, by the management unit, when a sum of a number of the first reproduction processings and a number of the second reproduction processings is larger than the maximum number of reproduction processings, a schedule of executing the first reproduction processings and the second reproduction processings.

5. The reproduction processing method according to claim 4, comprising:
obtaining, by the management unit, contents of an operation for executing the at least one first reproduction processing, a time interval of executing the at least one first reproduction processing, execution time of the at least one first reproduction processing, last execution time of the at least one first reproduction processing, and next execution time of the at least one first reproduction processing;
obtaining, by the management unit, a time interval of executing the at least one second reproduction processing, execution time of the at least one second reproduction processing, last execution time of the at least one second reproduction processing, and next execution time of the at least one second reproduction processing; and
setting, by the management unit, when the sum of the number of the first reproduction processings and the number of the second reproduction processings is larger than the maximum number of reproduction processings, next execution time of the first reproduction processings and next execution time of the second reproduction processings.

6. The reproduction processing method according to claim 1, wherein:
the reproduction processing includes at least one first reproduction processing and at least one second reproduction processing; and
the reproduction processing method comprises:
obtaining, by the management unit, response time of the storage processing unit when contents of the user's operation corresponding to the at least one first reproduction processing are operated, and response time of the storage processing unit when contents of the user's operation corresponding to the at least one second reproduction processing are operated;
designating, by the management unit, a second reproduction processing executed simultaneously with a first reproduction processing by the same reproduction unit as a reproduction unit for executing the first reproduction processing;
obtaining, by the management unit, response time of the at least one first reproduction processing, response time of the at least one second reproduction processing, and a threshold value of predesignated response time; and
creating, by the management unit, a schedule of executing the at least one first reproduction processing and the at least one second reproduction processing based on the response time and the threshold value.

7. The reproduction processing method according to claim 1, wherein:
the reproduction processing includes at least one first reproduction processing and at least one second reproduction processing; and
the reproduction processing method comprises:
obtaining, by the management unit, response time when the at least one first reproduction processing is reproduced by the at least one reproduction unit and response time when the at least one second reproduction processing is reproduced by the at least one reproduction unit;
obtaining, by the management unit, a threshold value of predesignated response time; and
creating, by the management unit, a schedule of executing the at least one first reproduction processing and the at least one second reproduction processing based on the response time and the threshold value.

8. The reproduction processing method according to claim 1, wherein:
the reproduction processing includes at least one first reproduction processing and at least one second reproduction processing;
the at least one reproduction unit is realized by a plurality of virtual computers configured on a plurality of physical computers; and
the reproduction processing method comprises:
calculating, by the management unit, an amount of physical resources of the at least one reproduction unit necessary for executing the at least one first reproduction processing and the at least one second reproduction processing by the at least one reproduction unit;
calculating, by the management unit, an amount of physical resources used for executing a plurality of the second reproduction processings executed by the at least one reproduction unit for executing the at least one first reproduction processing, and an amount of physical resources not used for executing the second reproduction processings; and
allocating, by the management unit, when the amount of physical resources not used for executing the second reproduction processings is smaller than the amount of physical resources necessary for executing the at least one first reproduction processing, new physical resources to the at least one reproduction unit.

9. A computer system comprising:
at least one processor for executing a program; and
a memory coupled to the at least one processor,
the processor being configured to realize a storage processing unit for storing user's operation of the computer system, at least one reproduction unit for reproducing the user's operation, and a management unit for managing a schedule of the reproduction by executing the program, wherein:
the storage processing unit is configured to:
store contents of the user's operation; and
transmit the stored contents of the user's operation to the management unit,
the management unit is configured to:
determine a reproduction unit of the at least one reproduction unit for executing a reproduction processing according to the contents of the user's operation;
determine a schedule of executing the reproduction processing; and
transmit the stored contents of the user's operation and the determined schedule to the determined reproduction unit,
the determined reproduction unit is configured to execute the reproduction processing based on the received contents of the user's operation and the schedule.

10. The computer system according to claim 9, wherein:
the management unit is configured to:
select at least one reproduction unit as a candidate for executing the reproduction processing from the at least one reproduction unit; and
transmit the stored contents of the user's operation to the selected at least one reproduction unit;
the selected at least one reproduction unit is configured to:
execute the reproduction processing based on the received contents of the user's operation; and
return an execution result of the reproduction processing to the management unit; and
the management unit is configured to determine the reproduction unit for executing the reproduction processing.

11. The computer system according to claim 9, wherein the management unit is configured to:
obtain first setting information indicating setting of the storage processing unit when the contents of the user's operation stored in the storage processing unit are operated;
obtain second setting information indicating setting of the at least one reproduction unit when the contents of the user's operation stored in the storage processing unit are operated;
compare the obtained first setting information with the obtained second setting information; and
determine the reproduction unit for executing the reproduction processing based on a comparison result of the first setting information and the second setting information.

12. The computer system according to claim 9, wherein:
the reproduction processing includes at least one first reproduction processing and at least one second reproduction processing different from the first reproduction processing; and
the management unit is configured to:
determine a reproduction unit for executing the at least one first reproduction processing;
designate second reproduction processings executed by the reproduction unit for executing the at least one first reproduction processing;
obtain a maximum number of reproduction processings executable by the reproduction unit; and
create, when a sum of a number of the first reproduction processings and a number of the second reproduction processings is larger than the maximum number of reproduction processings, a schedule of executing the first reproduction processings and the second reproduction processings.

13. The computer system according to claim 12, wherein the management unit is configured to:
obtain contents of an operation for executing the at least one first reproduction processing, a time interval of executing the at least one first reproduction processing, execution time of the at least one first reproduction processing, last execution time of the at least one first reproduction processing, and next execution time of the at least one first reproduction processing;
obtain a time interval of executing the at least one second reproduction processing, execution time of the at least one second reproduction processing, last execution time of the at least one second reproduction processing, and next execution time of the at least one second reproduction processing; and
set, when the sum of the number of the first reproduction processings and the number of the second reproduction processings is larger than the maximum number of reproduction processings, next execution time of the first reproduction processings and next execution time of the second reproduction processings.

14. The computer system according to claim 9, wherein:
the reproduction processing includes at least one first reproduction processing and at least one second reproduction processing; and
the management unit is configured to:
obtain response time of the storage processing unit when contents of the user's operation corresponding to the at least one first reproduction processing are operated, and response time of the storage processing unit when contents of the user's operation corresponding to the at least one second reproduction processing are operated;
designate a second reproduction processing executed simultaneously with a first reproduction processing by the same reproduction unit as a reproduction unit for executing the first reproduction processing;
obtain response time of the at least one first reproduction processing, response time of the at least one second reproduction processing, and a threshold value of predesignated response time; and
create a schedule of executing the at least one first reproduction processing and the at least one second reproduction processing based on the response time and the threshold value.

15. The computer system according to claim 9, wherein:
the reproduction processing includes at least one first reproduction processing and at least one second reproduction processing; and
the management unit is configured to:
obtain response time when the at least one first reproduction processing is reproduced by the at least one reproduction unit and response time when the at least one second reproduction processing is reproduced by the at least one reproduction unit;
obtain a threshold value of predesignated response time; and
create a schedule of executing the at least one first reproduction processing and the at least one second reproduction processing based on the response time and the threshold value.

16. The computer system according to claim 9, wherein:
the reproduction processing includes at least one first reproduction processing and at least one second reproduction processing;
the at least one reproduction unit is realized by a plurality of virtual computers configured on a plurality of physical computers; and
the management unit is configured to:
calculate an amount of physical resources of the at least one reproduction unit necessary for executing the at least one first reproduction processing and the at least one second reproduction processing by the at least one reproduction unit;
calculate an amount of physical resources used for executing a plurality of the second reproduction processings executed by the at least one reproduction unit for executing the at least one first reproduction processing, and an amount of physical resources not used for executing the second reproduction processings; and
allocate, when the amount of physical resources not used for executing the second reproduction processings is smaller than the amount of physical resources necessary for executing the at least one first reproduction processing, new physical resources to the at least one reproduction unit.

17. A computer readable medium embodying a program executed by at least one processor for controlling a computer system to execute a processing of reproducing a stored operation,
the computer system including the at least one processor for executing the program and a memory coupled to the at least one processor,
the processor being configured to realize a storage processing unit for storing user's operation of the computer system, at least one reproduction unit for reproducing the user's operation, and a management unit for managing a schedule of the reproduction by executing the program,
the program controlling the computer system to execute:
storing, by the storage processing unit, contents of the user's operation;
transmitting, by the storage processing unit, the stored contents of the user's operation to the management unit;
determining, by the management unit, a reproduction unit of the at least one reproduction unit for executing a reproduction processing according to the contents of the user's operation;
determining, by the management unit, a schedule of executing the reproduction processing;
transmitting, by the management unit, the stored contents of the user's operation and the determined schedule to the determined reproduction unit; and
executing, by the determined reproduction unit, the reproduction processing based on the received contents of the user's operation and the schedule.
